(19) United States
(12) Patent Application Publication
(10) Pub. No.: US 2025/0392520 A1
(43) Pub. Date: Dec. 25, 2025

(54) NETWORK FUNCTION IMPLEMENTATION METHOD AND APPARATUS

(71) Applicant: HUAWEI TECHNOLOGIES CO., LTD., Shenzhen (CN)

(72) Inventors: Mingyu Zhao, Shanghai (CN); Xueqiang Yan, Shanghai (CN); Yan Xi, Shanghai (CN); Shaoyun Wu, Shanghai (CN)

(73) Assignee: HUAWEI TECHNOLOGIES CO., LTD., Shenzhen (CN)

(21) Appl. No.: 19/305,774

(22) Filed: Aug. 21, 2025

Related U.S. Application Data
(63) Continuation of application No. PCT/CN2023/080303, filed on Mar. 8, 2023.

(51) Int. Cl. H04L 41/14; H04L 41/5003

(52) U.S. Cl. CPC H04L 41/145; H04L 41/5003

(57) ABSTRACT

This application provides a network function implementation method and an apparatus, to implement a network function when a distributed network architecture meets a trustworthiness requirement. The method includes: Receiving first information from a first network function (NF) network element and second information from a second NF network element, obtaining a first model and first data based on the second information, and determining a response to a service requirement based on the first model and the first data. The second information indicates a storage status of data needed for fulfilling the service requirement within a third NF network element, the second NF network element is configured to record the storage status of the data by using a distributed ledger technology, the third NF network element is configured to store the data by using a distributed hash table technology, and model data within the data is used to determine the first model.

### CROSS-REFERENCE TO RELATED APPLICATIONS

This application is a continuation of International Application No. PCT/CN2023/080303, filed on Mar. 8, 2023, the disclosure of which is hereby incorporated by reference in its entirety.

### TECHNICAL FIELD

Embodiments of this application relate to the communication field, and in particular, to a network function implementation method and an apparatus.

### BACKGROUND

With the widespread deployment of distributed edge computing and intelligent user equipment (UE), along with the advancement and extensive application of perception and artificial intelligence (AI) technologies, the computational power, intelligence, and data within a network architecture of a future 6th generation mobile communication system (6G) will require support from a distributed network architecture.

In addition, with the enforcement of related laws and regulations such as the personal information protection law (PIPL) and the general data protection regulation (GDPR), considerations for user data security and user privacy protection need to be integrated at the network architecture layer.

Therefore, when the distributed network architecture ensures the user data security and user privacy security (for example, meeting trustworthiness requirements), there is an urgent discussion about how to implement a network function (NF) in the distributed network architecture.

### SUMMARY

Embodiments of this application provide a network function implementation method and an apparatus, to implement a network function of a distributed network architecture when the distributed network architecture meets user data security and user privacy security.

According to a first aspect, a network function implementation method is provided. The method may be performed by a sixth network function (NF) network element, or may be performed by a component of the sixth NF network element, for example, a processor, a communication interface, a chip, or a chip system of the sixth NF network element, or may be implemented by a logical module or software that can implement all or some functions of the sixth NF network element. The method includes: receiving first information from a first NF network element, where the first information indicates a model type and a data type that correspond to a service requirement of the first NF network element; receiving second information from a second NF network element, where the second information indicates a storage status of data needed for fulfilling the service requirement within a third NF network element, the second NF network element is configured to record the storage status of the data by using a distributed ledger technology, the third NF network element is configured to store the data by using a distributed hash table technology, the data includes model data corresponding to the model type and first data corresponding to the data type, and the model data is used to determine a first model; obtaining the first model and the first data based on the second information; and determining a response to the service requirement based on the first model and the first data.

According to this solution, the second NF network element is configured to record, by using the distributed ledger technology, the storage status of the data needed for implementing the service (that is, on-chain storage), and the third NF network element is configured to store the data by using the distributed hash table technology (that is, off-chain storage). Security of user data and security of user privacy are improved through a combination of the on-chain storage and the off-chain storage, thereby meeting a trustworthiness requirement on a distributed network architecture. When the trustworthiness requirement on the distributed network architecture is met, the sixth NF network element determines, from the second NF network element based on the model type and the data type that correspond to the service requirement, the storage status of the data needed for implementing the service requirement, further obtains, based on the storage status of the data, the first model and the first data that correspond to the service requirement, and determines the response to the service requirement based on the first data and the first model. Therefore, a network function can be implemented when the distributed network architecture meets the trustworthiness requirement.

In an optional design, the second NF network element may be a DLT network element, and the third NF network element may be a DHT network element.

In an optional design, the second information includes first indication information, the first indication information indicates whether the third NF network element stores the first model, and when the first indication information indicates that the third NF network element stores the first model, the first indication information further indicates whether the first model needs to be updated. When the first indication information indicates that the first model is not stored in the third NF network element, the model data includes second data, where the second data is used to obtain the first model through training; when the first indication information indicates that the third NF network element stores the first model and the first model does not need to be updated, the model data includes the first model; or when the first indication information indicates that the third NF network element stores the first model and the first model needs to be updated, the model data includes the first model and third data, where the third data is used to update the first model to obtain a second model.

In an optional design, the second information further includes a first pointer. When the first indication information indicates that the first model is not stored in the third NF network element, the first pointer indicates a first storage address, where the first storage address is a storage address of the second data in the third NF network element, and the second data is used to train the first model; when the first indication information indicates that the third NF network element stores the first model and the first model does not need to be updated, the first pointer indicates a second storage address, where the second storage address is a storage address of the first model in the third NF network element; or when the first indication information indicates that the third NF network element stores the first model and the first model needs to be updated, the first pointer indicates a third storage address and the second storage address, where the third storage address is a storage address of the third data in the third NF network element, and the third data is used to update the first model.

According to the optional design, for different scenarios indicated by the first indication information, the first pointer indicates a storage address of the first model, a storage address of data used to obtain the first model (that is, the second data), or a storage address of data used to obtain the second model (that is, the first model and the third data), so that the sixth NF network element can obtain, from the storage address based on the first pointer, the first model, the data used to obtain the first model, or the data used to obtain the second model.

In an optional design, that the sixth NF network element obtains the first model based on the second information includes: The sixth NF network element obtains the first model based on the first indication information and the first pointer.

In an optional design, when the first indication information indicates that the first model is not stored in the third NF network element, that the sixth NF network element obtains the first model based on the second information includes: The sixth NF network element obtains the second data from the first storage address, sends the second data to a fourth NF network element, where the fourth NF network element is configured to obtain the first model through training, and receives the first model from the fourth NF network element.

In an optional design, the network function implementation method further includes: The sixth NF network element sends the first model to the third NF network element.

According to the optional design, when the first model is not stored in the third NF network element, the sixth NF network element obtains, from the third NF network element, the second data used to train the first model, and then obtains the first model through training the first model by the fourth NF network element. In addition, the first model is stored in the third NF network element, so that when another NF network element needs to use the first model, the another NF network element can directly use the first model without retraining, thereby reducing resource consumption and improving system running efficiency.

In an optional design, when the first indication information indicates that the third NF network element stores the first model and the first model does not need to be updated, that the sixth NF network element obtains the first model based on the second information includes: The sixth NF network element obtains the first model from the second storage address.

According to the optional design, when the third NF network element stores the first model and the first model does not need to be updated, the sixth NF network element directly obtains the first model from the third NF network element. In this way, when another NF network element needs to use the first model, the another NF network element can directly use the first model without retraining, thereby reducing resource consumption and improving system running efficiency.

In an optional design, when the third NF network element stores the first model and the first model needs to be updated, that the sixth NF network element obtains the first model based on the second information includes:

The sixth NF network element obtains the first model from the second storage address, and obtains the third data from the third storage address. In addition, the network function implementation method further includes: The sixth NF network element sends the third data and the first model to a fourth NF network element, and receives the second model from the fourth NF network element, where the second model is an updated first model.

In an optional design, the network function implementation method further includes: The sixth NF network element sends the second model to the third NF network element.

In an optional design, that the sixth NF network element determines the response to the service requirement based on the first model and the first data includes: determining the response to the service requirement based on the second model and the first data.

In an optional design, when the first indication information indicates that the third NF network element stores the first model and the first model needs to be updated, the first pointer includes a first sub-pointer and a second sub-pointer. The first sub-pointer indicates the third storage address, and the second sub-pointer indicates the second storage address.

In an optional design, the second information includes second indication information, and the second indication information indicates whether the third NF network element stores the first data.

In an optional design, the second information further includes a second pointer. When the second indication information indicates that the third NF network element stores the first data, the second pointer indicates a fourth storage address, where the fourth storage address is a storage address of the first data in the third NF network element; or when the second indication information indicates that the first data is not stored in the third NF network element, the second pointer indicates a fifth storage address, where the fifth storage address is a storage address of the first data in a fifth NF network element, and the fifth NF network element is configured to provide data corresponding to the service requirement.

According to the optional design, for different scenarios indicated by the second indication information (for example, whether the third NF network element stores the first data), the second pointer indicates storage addresses of the first data in the different scenarios, so that the sixth NF network element can obtain the first data based on the storage address.

In an optional design, that the sixth NF network element obtains the first data based on the second information includes: The sixth NF network element obtains the first data based on the second indication information and the second pointer.

In an optional design, when the second indication information indicates that the third NF network element stores the first data, obtaining the first data based on the second information includes:

The sixth NF network element obtains the first data from the fourth storage address.

In an optional design, when the second indication information indicates that the first data is not stored in the third NF network element, obtaining the first data based on the second information includes: The sixth NF network element sends third information to the fifth NF network element, where the third information is used to request the fifth NF network element to store, in the third NF network element, the first data stored in the fifth storage address, and receives the first data from the third NF network element.

In an optional design, that the sixth NF network element receives the first information from the first NF network element includes: The sixth NF network element receives a first message from the first NF network element, where the first message includes the first information and a digital signature of the first NF network element. The digital signature of the first NF network element is used to verify integrity of the first information.

According to this optional design, the digital signature of the first NF network element can be used to ensure data security of the first information, to avoid reduction in accuracy of the response to the service requirement caused because the first message is tampered with.

In an optional design, the second information further includes access strategy information, and the access strategy information indicates whether the first NF network element has data access permission.

In an optional design, that the sixth NF network element obtains the first model based on the second information includes: When the access strategy information indicates that the first NF network element has the data access permission, the sixth NF network element obtains the first model based on the second information.

In an optional design, that the sixth NF network element obtains the first data based on the second information includes: When the access strategy information indicates that the first NF network element has the data access permission, the sixth NF network element obtains the first data based on the second information.

In an optional design, that the sixth NF network element determines the response to the service requirement based on the first model and the first data includes: The sixth NF network element compares a first hash value of the first model with a second hash value of the first model, where the first hash value is a hash value of the first model calculated by the third NF network element, and the second hash value is a hash value of the first model recorded in the second NF network element, and when the first hash value is consistent with the second hash value, determines the response to the service requirement based on the first model and the first data.

According to this optional design, because the first model is stored off a chain (that is, in the third NF network element), and the second hash value of the first model is recorded on the chain (that is, in the second NF network element), the first model stored off the chain may be tampered with. Before determining the response to the service requirement, the sixth NF network element may compare the first hash value with the second hash value, to determine whether the first model is tampered with. When the first hash value is consistent with the second hash value, it indicates that the first model is not tampered with. That is, after determining that the first model is not tampered with, the sixth NF network element determines the response to the service requirement based on the first model and the first data. This avoids determining the response to the service requirement by using a tampered first model. In this way, accuracy of the response to the service requirement is improved.

In an optional design, that the sixth NF network element determines the response to the service requirement based on the first model and the first data includes: The sixth NF network element compares a fifth hash value of the first model with a second hash value of the first model, where the fifth hash value is a hash value that is of the first model and that is determined by the sixth NF network element, and the second hash value is a hash value that is of the first model and that is recorded in the second NF network element, and when the fifth hash value is consistent with the second hash value, determines the response to the service requirement based on the first model and the first data.

According to the optional design, the first model may be tampered with in a process in which the third NF network element sends the first model to the sixth NF network element. Therefore, before determining the response to the service requirement, the sixth NF network element compares the fifth hash value with the second hash value, to determine whether the first model is tampered with in the process of transmitting the first model from the third NF network element to the sixth NF network element. When the fifth hash value is consistent with the second hash value, it indicates that the first model is not tampered with. That is, after determining that the first model is not tampered with, the sixth NF network element determines the response to the service requirement based on the first model and the first data. This avoids determining the response to the service requirement by using a tampered first model. In this way, accuracy of the response to the service requirement is improved. In an optional design, that the sixth NF network element determines the response to the service requirement based on the first model and the first data includes: The sixth NF network element compares a third hash value of the first data with a fourth hash value of the first data, where the third hash value is a hash value of the first data calculated by the third NF network element, and the fourth hash value is a hash value of the first data recorded in the second NF network element, and when the third hash value is consistent with the fourth hash value, determines the response to the service requirement based on the first model and the first data.

According to the optional design, the first data is stored off the chain (that is, in the third NF network element), and the fourth hash value of the first data is recorded on the chain (that is, in the second NF network element). Consequently, the first data stored off the chain may be tampered with. Before determining the response to the service requirement, the sixth NF network element compares the third hash value with the fourth hash value, to determine whether the first data is tampered with. When the third hash value is consistent with the fourth hash value, it indicates that the first data is not tampered with. That is, after determining that the first data is not tampered with, the sixth NF network element determines the response to the service requirement based on the first model and the first data. This avoids determining the response to the service requirement by using tampered first data. In this way, accuracy of the response to the service requirement is improved.

In an optional design, that the sixth NF network element determines the response to the service requirement based on the first model and the first data includes: The sixth NF network element compares a sixth hash value of the first data with a fourth hash value of the first data, where the sixth hash value is a hash value that is of the first data and that is determined by the sixth NF network element, and the fourth hash value is a hash value that is of the first data and that is recorded in the second NF network element, and when the sixth hash value is consistent with the fourth hash value, determines the response to the service requirement based on the first model and the first data.

According to the optional design, the first data may be tampered with in a process in which the third NF network element sends the first data to the sixth NF network element. Therefore, before determining the response to the service requirement, the sixth NF network element compares the sixth hash value with the fourth hash value, to determine whether the first data is tampered with in the process of transmitting the first data from the third NF network element to the sixth NF network element. When the sixth hash value is consistent with the fourth hash value, it indicates that the first data is not tampered with. That is, after determining that the first data is not tampered with, the sixth NF network element determines the response to the service requirement based on the first model and the first data. This avoids determining the response to the service requirement by using tampered first data. In this way, accuracy of the response to the service requirement is improved.

According to a second aspect, a communication apparatus is provided, to implement various methods. The communication apparatus may be the sixth NF network element in the first aspect, or an apparatus included in the sixth NF network element, for example, a chip or a chip system. The communication apparatus includes a corresponding module, unit, or means for implementing the methods. The module, unit, or means may be implemented by hardware, software, or hardware executing corresponding software. The hardware or the software includes one or more modules or units corresponding to functions.

In some optional designs, the communication apparatus may include a processing module and a communication module. The processing module may be configured to implement a processing function in any one of the foregoing aspects and the optional implementations of the foregoing aspects. The communication module may include a receiving module and a sending module that are respectively configured to implement a receiving function and a sending function in any one of the foregoing aspects or the optional implementations of the foregoing aspects.

In some optional designs, the communication module may include a transceiver circuit, a transceiver, a transceiver device, or a communication interface.

According to a third aspect, a communication apparatus is provided, including a processor and a memory. The memory is configured to store computer instructions. When the processor executes the instructions, the communication apparatus is caused to perform the method according to any one of the aspects. The communication apparatus may be the sixth NF network element in the first aspect, or an apparatus included in the sixth NF network element, for example, a chip or a chip system.

According to a fourth aspect, a communication apparatus is provided, including a processor and a communication interface. The communication interface is configured to communicate with a module other than the communication apparatus, and the processor is configured to execute a computer program or instructions, so that the communication apparatus is caused to perform the method according to any one of the aspects. The communication apparatus may be the sixth NF network element in the first aspect, or an apparatus included in the sixth NF network element, for example, a chip or a chip system.

According to a fifth aspect, a communication apparatus is provided, including at least one processor. The processor is configured to execute a computer program or instructions stored in a memory, so that the communication apparatus is caused to perform the method according to any one of the aspects. The memory may be coupled to the processor, or may be independent of the processor. The communication apparatus may be the sixth NF network element in the first aspect, or an apparatus included in the sixth NF network element, for example, a chip or a chip system.

In some optional designs, the communication apparatus includes the memory, and the memory is configured to store necessary program instructions and data.

In some optional designs, when the apparatus is a chip system, the apparatus may include a chip, or may include a chip and another discrete component.

It can be understood that, when the communication apparatus provided in any one of the second to the fifth aspects is a chip, a sending action/function of the communication apparatus may be understood as information output, and a receiving action/function of the communication apparatus may be understood as information input.

According to a sixth aspect, a computer-readable storage medium is provided. The computer-readable storage medium stores a computer program or instructions. When the computer program or the instructions run on a communication apparatus, the communication apparatus is caused to perform the method according to any one of the aspects, or the communication apparatus is caused to run the apparatus according to any one of the aspects.

According to a seventh aspect, a computer program product including instructions is provided. When the computer program product runs on a communication apparatus, the communication apparatus is caused to perform the method according to any one of the aspects, or the communication apparatus is caused to run the apparatus according to any one of the aspects.

For technical effects of any design manner of the second aspect to the seventh aspect, refer to the technical effects of different design manners of the first aspect, and details are not described herein again.

### BRIEF DESCRIPTION OF DRAWINGS

FIG. 1 is a diagram of a trustworthy-distributed hash table (T-DHT) technology according to this application;

FIG. 2 is a diagram of a distributed network architecture according to this application;

FIG. 3 is a diagram of another distributed network architecture according to this application;

FIG. 4 is a schematic flowchart of an NF implementation method according to this application;

FIG. 5 is a diagram of a first message and a second message in an NF implementation method according to this application;

FIG. 6 is a schematic flowchart of another NF implementation method according to this application;

FIG. 7a is a schematic flowchart of another NF implementation method according to this application;

FIG. 7b is a schematic flowchart of another NF implementation method according to this application;

FIG. 7c is a schematic flowchart of another NF implementation method according to this application;

FIG. 8a is a schematic flowchart of another NF implementation method according to this application;

FIG. 8b is a schematic flowchart of another NF implementation method according to this application;

FIG. 9 is a diagram of another distributed network architecture according to this application;

FIG. 10 is a diagram of another distributed network architecture according to this application;

FIG. 11 is a diagram of another distributed network architecture according to this application;

FIG. 12 is a diagram of another distributed network architecture according to this application;

FIG. 13 is a diagram of another distributed network architecture according to this application;

FIG. 14 is a diagram of another distributed network architecture according to this application;

FIG. 15 is a diagram of a structure of a communication apparatus according to this application; and

FIG. 16 is a diagram of a structure of another communication apparatus according to this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

The terms “first” and “second” mentioned below are merely intended for a purpose of description, and shall not be understood as an indication or implication of relative importance or implicit indication of the quantity of indicated technical features. Therefore, a feature limited by “first”, “second”, or the like may explicitly or implicitly indicate that one or more such features are included.

### 1. Distributed Network Architecture

A distributed system is a system in which hardware or software components are distributed on different computers and communication and coordination between different computers are performed through message transfer. A system architecture of such a system constitutes a distributed network architecture.

The distributed system has the following functionalities: (1) Resource sharing among various nodes; (2) Enhanced operational speed: for instance, during task execution, tasks can be broken down into multiple sub-tasks assigned to different nodes, thereby accelerating computational processes; (3) High reliability: meaning that even if some nodes fail, the entire distributed system continues functioning as non-failed nodes remain operational.

### 2. Network Data Analysis Function (NWDAF)

The NWDAF can be used for big data analysis, for example, obtaining data, analyzing the data, and providing data analysis results to other network elements, application functions for utilization, and the like. The NWDAF may further offer functionalities of training models and conducting inference based on the trained models, and the like.

Specifically, the functionalities of the NWDAF may be distributed to a plurality of independent instances. These instances can operate independently, and provide some functions of the NWDAF. For example, a model training logical function (MTLF) network element serving as an NWDAF instance can provide functions such as providing model training and providing models to other NWDAF instances. For another example, an analytics logical function (AnLF) network element serving as an NWDAF instance can obtain models from other NWDAF instances, and then perform data analysis based on the obtained models.

### 3. Distributed Technology

The distributed technology is mainly applied to the information technology (IT) field, including a distributed ledger technology (DLT), a distributed hash table (DHT) technology, and the like. The DHT can implement services such as distributed deployment, quick search, and access of a network function (NF), can meet requirements of decentralization and autonomy, and has features such as a fault tolerance mechanism and scalability.

With the widespread deployment of infrastructures with distributed edge computing functions and intelligent user equipment (UE), along with the advancement and extensive application of wide application of perception and artificial intelligence (AI) technologies, the computational power, intelligence, and data within a network architecture of a future 6th generation mobile communication system (6G), will require support from a distributed network architecture.

However, with implementation of data-related laws and regulations such as the personal information protection (PIPL) and the general data protection regulation (GDPR), requirements of user data security and user privacy protection need to be considered at a network architecture layer, in other words, a trustworthiness requirement on a network function needs to be implemented.

Based on this, in the 3rd generation partnership project (3GPP) communication system, a data collection collaboration function (DCCF) network element, a messaging framework adaptor function (MFAF) network element, and an analytics data repository function (ADRF) network element are introduced based on the NWDAF, to implement a trustworthiness requirement on the NF in the distributed network architecture. The DCCF is configured to coordinate data collection and distribution, to avoid a plurality of subscriptions and responses to same data. The MFAF is configured to perform processing such as formatting on data, and may perform adapting between protocols defined in 3GPP. The ADRF is configured to store, retrieve, and analyze data.

For example, when having a data analysis requirement, a data consumer network element may send a data analysis request to the DCCF network element. The DCCF network element forwards the request to the AnLF network element, and the AnLF network element performs data analysis. The AnLF network element needs to use a model and related data to complete data analysis. Therefore, the AnLF network element obtains the model and the related data via the DCCF network element.

When the ADRF network element stores the related data, the DCCF network element may indicate the ADRF network element to send the related data to the AnLF network element. When the related data is not stored in the ADRF network element, the DCCF network element may indicate a data provider network element to send the related data to the MFAF network element. After receiving the related data, the MFAF network element sends the related data to the AnLF network element. In addition, the MFAF network element further sends the related data to the ADRF network element for storage.

When the ADRF network element stores the model, the DCCF network element may indicate the ADRF network element to send the model to the AnLF network element. When the model is not stored in the ADRF network element, the DCCF network element may indicate the ADRF network element to send the historical data to the AnLF network element. After receiving the historical data, the AnLF network element forwards the historical data to the MTLF network element. The MTLF network element trains the model based on the historical data and returns the model to the AnLF network element.

The AnLF network element completes data analysis based on the related data and the model, obtains a response corresponding to the request, and returns the response to the data consumer network element via the DCCF network element.

However, in the foregoing network architecture, the model and related data are centrally stored in the ADRF network element. In this case, problems such as a single-point failure and DDOS may exist. In addition, in the solution, security of the related data and the model entirely relies on trust of users in operators. Therefore, reliability of the solution still requires improvement.

As described above, the current solution for implementing the trustworthiness requirement on the NF has some disadvantages. However, the 6G architecture has a distributed trend, and therefore it is necessary to consider to meet a trustworthiness requirement in the distributed network architecture. A solution that can be easily figured out is directly applying the distributed technology in the IT field to the distributed network architecture. However, when the distributed technology is directly applied to the distributed network architecture, some problems may exist:
(1) The DHT lacks a trustworthiness mechanism, and due to a discrete feature of the DHT technology, a detour problem exists in a node query process.
(2) The DLT is prone to problems such as block chain bloat and privacy leakage. In addition, due to a tamper-proof feature of the DLT, the DLT cannot meet requirements of related laws and regulations such as the PIPL and the GDPR on a right to delete data.
(3) Single-point technologies (DLT or DHT) have a security risk.

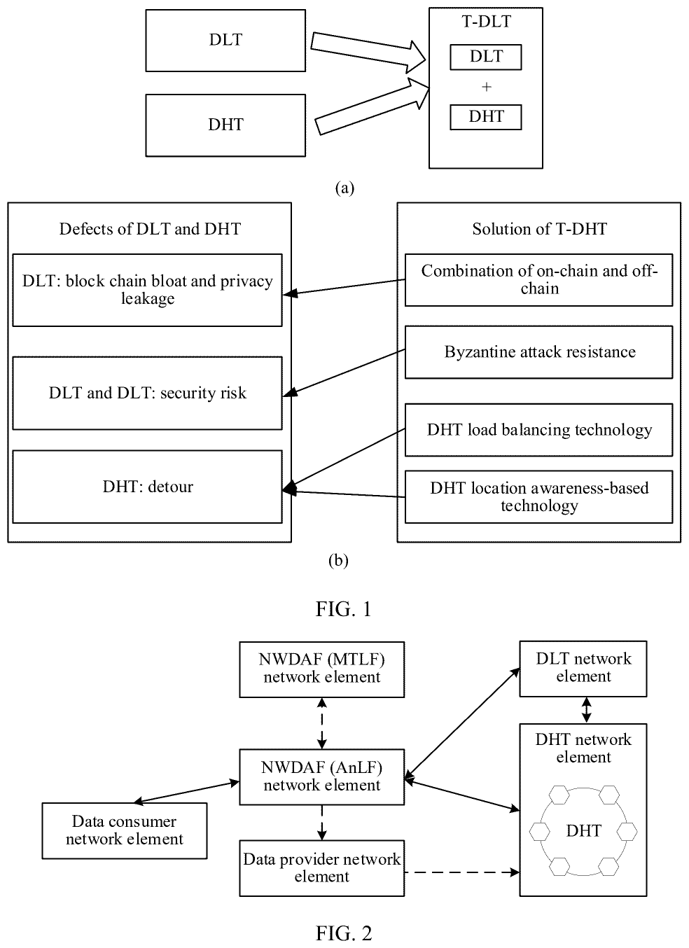

In view of this, this application provides a trustworthy-distributed hash table (T-DHT) technology, so that a distributed network architecture meets a trustworthiness requirement. As shown in (a) in FIG. 1, a T-DHT may be understood as an organic combination of a DLT and a DHT.

An ADRF network element is integrated into the DHT in the T-DHT. In other words, the DHT can implement storage of data (for example, the data may include at least one of related data and a related model, historical data corresponding to the related data and historical data corresponding to the related model, a model, and historical data corresponding to the model).

An authentication, authorization, and access control (AAA) function and a DCCF network element are integrated into the DLT in the T-DHT. In other words, the DLT can implement functions such as data access and control, and release of related data and/or a related model.

For example, as shown in (b) in FIG. 1, in the T-DHT technology, a manner of combining on-chain storage and off-chain storage may be used. In the storage manner, a part of data (for example, historical data used for model training and personal data of a user) is stored off a chain (that is, stored in the DHT), the other part of data (for example, public data such as a public key) is stored on the chain (that is, stored in the DLT), the data stored off the chain is packaged, and a hash value of packaged data is stored on the chain. In this storage manner, the historical data, the personal data, and the like are stored off the chain, and hash values of the historical data, the personal data, and the like are stored on the chain. Therefore, storage space on the chain is saved, and a problem of block chain bloat is resolved. In addition, data stored on the chain may be shared.

Therefore, model allocation and sharing can be implemented between a plurality of MTLF network elements. In addition, because the personal data of the user is stored off the chain, a risk of privacy leakage is reduced. In other words, in the T-DHT technology, a storage manner of combining the DHT and the DLT are used.

In addition, in the T-DHT technology, a security risk existing in a single-point technology may be resolved by using a Byzantine attack resistance technology. The DHT is enhanced by using a tamper-proof feature of the DLT, so that the T-DHT technology has a trustworthiness feature. When a storage node is selected, a location relationship between a logical node and an actual node is considered based on a load balancing technology and a location awareness-based DHT solution, to resolve a detour problem existing in the DHT, and improve operation efficiency of a system.

Based on the foregoing T-DHT technology, this application provides a distributed network architecture. The distributed network architecture may include a first NF network element, a second NF network element, a third NF network element, and a sixth NF network element.

Optionally, the first NF network element is configured to provide a service requirement. For example, the first NF network element may be a data consumer network element.

Optionally, the second NF network element is configured to record, by using a distributed ledger technology, a storage status of data needed for implementing the service requirement. The storage status includes whether the third NF network element stores model data and first data that are needed for implementing the service requirement, and storage addresses of the model data and the first data.

For example, the second NF network element may be a DLT network element in a T-DHT. For ease of description, the DLT network element in the T-DHT is collectively referred to as a DLT network element in the following descriptions. Optionally, the third NF network element is configured to store the model data and the first data by using a distributed hash table technology. For example, the third NF network element may be a DHT network element in the T-DHT. For ease of description, the DHT network element in the T-DHT is collectively referred to as a DHT network element in the following descriptions.

Optionally, the third NF network element may separately calculate hash values of the model data and the first data that are stored in the third NF network element, and send the hash values to the second NF network element. The second NF network element records the hash values.

Optionally, the sixth NF network element has a function of determining a response corresponding to the service requirement. For example, the sixth NF network element may be an AnLF network element.

Optionally, the T-DHT-technology-based distributed network architecture provided in this application may further include at least one of a fourth NF network element or a fifth NF network element.

Optionally, the fourth NF network element has functions of model training and providing a model for another network element. For example, the fourth NF network element may be an MTLF network element.

Optionally, the fifth NF network element is configured to provide data corresponding to the service requirement. For example, the fifth NF network element may be a data provider network element.

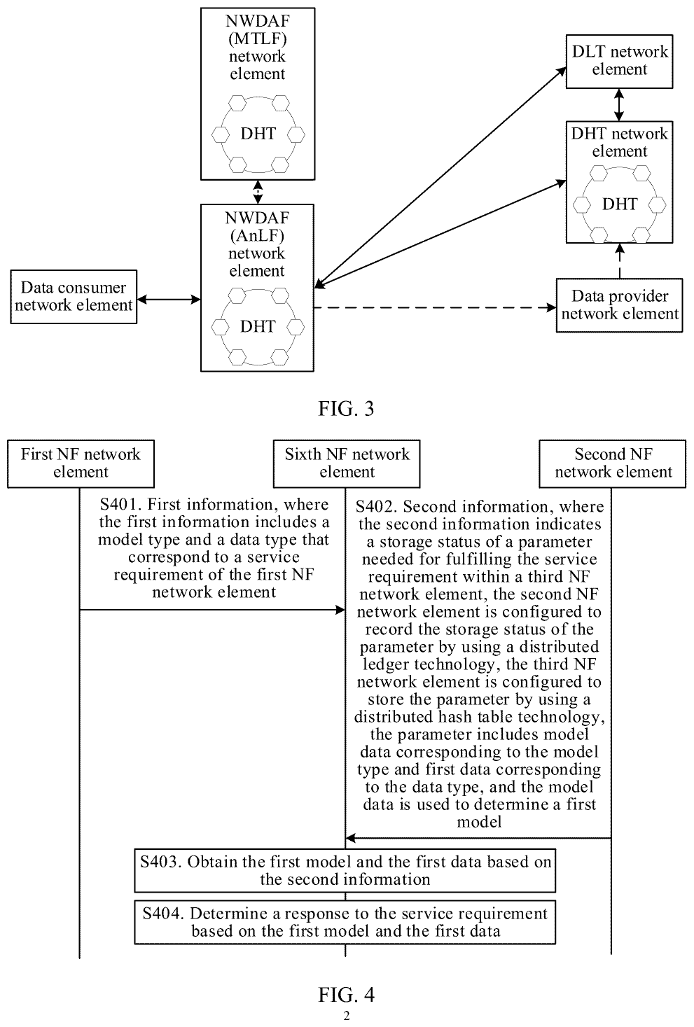

For example, the first NF network element is the data consumer network element, the second NF network element is the DLT network element, the third NF network element is the DHT network element, the fourth NF network element is the MTLF network element, the fifth NF network element is the data provider network element, and the sixth NF network element is the AnLF network element. The distributed network architecture provided in this application may be shown in FIG. 2 or FIG. 3.

Refer to FIG. 2 or FIG. 3. The data consumer network element, the AnLF network element, and the DHT network element may interact with each other, the DLT network element, the AnLF network element, and the DHT network element may interact with each other, and the AnLF network element may further interact with the MTLF network element. In the distributed network architecture shown in FIG. 2, the AnLF network element and the MTLF network element are implemented without using a DHT technology. In the distributed network architecture shown in FIG. 3, the AnLF network element and the MTLF network element are implemented by using the DHT technology.

In addition to the foregoing distributed network architecture, this application further provides a network function implementation method, to implement a network function in the foregoing distributed network architecture. The following describes the network function implementation method provided in this application with reference to the accompanying drawings. It may be understood that some or all of the steps in embodiments of this application may be executed. The steps or operations are merely examples. Other operations or variations of various operations may further be implemented in embodiments of this application. In addition, the steps may be performed in a sequence different from a sequence presented in embodiments of this application, and not all the operations in embodiments of this application may be performed.

It should be noted that, in the following embodiments of this application, names of messages or names of parameters in messages of devices are merely examples, and the messages or the parameters may have other names in specific implementations. This is not specifically limited in embodiments of this application. FIG. 4 shows a network function implementation method according to an embodiment of this application. The network function implementation method includes the following steps.

S401. A first NF network element sends first information to a sixth NF network element. Correspondingly, the sixth network element receives the first information from the first network element. The first information indicates a model type and a data type that correspond to a service requirement of the first NF network element. Optionally, the first information may include the model type and the data type that correspond to the service requirement.

For example, the service requirement includes but is not limited to a data analysis requirement, for example, analyzing and predicting a status of an event (for example, a service load) in a specific time period, or analyzing whether an event is true or false (for example, whether a reason why an alarm gives an alert is that a real alarming situation occurs).

Optionally, the service requirement may be generated by an application layer of the first NF network element, or may be sent by another network element to the first NF network element, or may be input by a user. This is not specifically limited in this application.

Optionally, after obtaining the service requirement, the first NF network element may determine, based on a preconfigured correspondence, the model type and the data type that correspond to the service requirement, to include, in the first information, the model type and the data type that correspond to the service requirement.

For example, the preconfigured correspondence may include a model type and a data type that correspond to each of a plurality of service requirements.

Optionally, after receiving the first information, the sixth NF network element determines, based on the model type and the data type that correspond to the service requirement, model data and first data that are needed for implementing the service requirement. The model data is used to determine the first model, so that the sixth NF network element can implement the service requirement based on the first model and the first data (that is, a response corresponding to the service requirement).

Optionally, that the first NF network element sends the first information to the sixth NF network element includes: The first NF network element sends a first message to the sixth NF network element, where the first message includes the first information and a digital signature of the first NF network element. In other words, the first information may be carried in the first message. The digital signature of the first NF network element is used to verify integrity of the first information.

Based on this optional solution, the digital signature of the first NF network element can be used to ensure data security of the first information, to avoid reduction in accuracy of the response to the service requirement caused because the first message is tampered with.

Optionally, the first message may further include an identity (ID) of the first message.

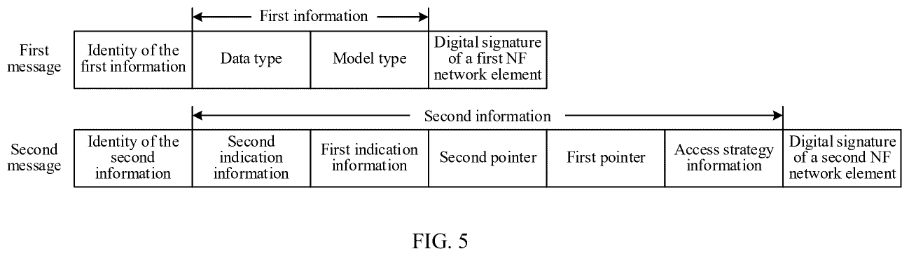

According to the optional solution, the ID of the first message is used to ensure uniqueness of the first message, to avoid waste of resources caused because a system repeatedly executes the service requirement of the first message by a system. As shown in FIG. 5, the first message may include the model type, the data type, the digital signature of the first NF network element, and the ID of the first message.

S402. A second NF network element sends second information to the sixth NF network element. Correspondingly, the sixth NF network element receives the second information from the second NF network element. The second information indicates a storage status of data needed for implementing the service requirement in a third NF network element. The storage status includes whether the third NF network element stores the model data and the first data that are needed for implementing the service requirement, and storage addresses of the model data and the first data. The model data is used to determine the first model.

Optionally, the second information may include first indication information. The first indication information indicates whether the third NF network element stores the first model, and when the first indication information indicates that the third NF network element stores the first model, the first indication information further indicates whether the first model needs to be updated.

When the first indication information indicates that the first model is not stored in the third NF network element, the model data includes second data, where the second data is used to obtain the first model through training; when the first indication information indicates that the third NF network element stores the first model and the first model does not need to be updated, the model data includes the first model; or when the first indication information indicates that the third NF network element stores the first model and the first model needs to be updated, the model-related data includes the first model and third data, where the third data is used to update the first model to obtain a second model.

For example, because the second NF network element records the storage status of the data that is needed for the service requirement and that is in the third NF network element, the second NF network element may determine, by determining whether the first model is recorded, whether the third NF network element stores the first model. For example, if the second NF network element stores a hash value of the first model (in other words, the second NF network element records the first model), it indicates that the third NF network element stores the first model, and the first model does not need to be updated. If the second NF network element stores a hash value of the second data (in other words, the second NF network element records the second data), it indicates that the first model is not stored in the third NF network element. If the second NF network element stores the hash value of the first model and a hash value of the third data (in other words, the second NF network element records the first model and the third data), it indicates that the third NF network element stores the first model, and the first model needs to be updated.

Optionally, different functions of the first indication information may be indicated by using different bit values.

For example, the first indication information is indicated by using two bits. When a value of the two bits is 00, the first indication information indicates that the first model is not stored in the third NF network element. When the value of the two bits is 01, the first indication information indicates that the third NF network element stores the first model and the first model needs to be updated. When the value of the two bits is 10, the first indication information indicates that the third NF network element stores the first model and the first model does not need to be updated.

It should be noted that the foregoing descriptions are merely example descriptions of a correspondence between the value of the two bits of the first indication information and a function of the first indication information. It is clear that the correspondence between the value of the two bits and the function of the first indication information is not limited to the foregoing example. Actually, there may be another correspondence case. For example, when the value of the two bits is 11, the first indication information indicates that the first model is not stored in the third NF network element. Details are not described herein in this application.

Optionally, the second information may further include a first pointer. For example, the first pointer may be implemented in the following three optional manners.

In a first optional implementation, when the first indication information indicates that the first model is not stored in the third NF network element, the first pointer indicates a first storage address. The first storage address is a storage address of the second data in the third NF network element.

In a second optional implementation, when the first indication information indicates that the third NF network element stores the first model and the first model does not need to be updated, the first pointer indicates a second storage address. The second storage address is a storage address of the first model in the third NF network element.

In a third optional implementation, when the first indication information indicates that the first model stored in the third NF network element needs to be updated, the first pointer indicates a third storage address and the second storage address. The third storage address is a storage address of the third data in the third NF network element.

Optionally, the first pointer indicates the third storage address and the second storage address in the following manner: The first pointer includes a first sub-pointer and a second sub-pointer. For example, the first sub-pointer indicates the third storage address, and the second sub-pointer indicates the second storage address.

According to this optional solution, for different scenarios indicated by the first indication information, the first pointer indicates a storage address of the first model, a storage address of data used to obtain the first model (that is, the second data), or a storage address of data used to obtain the second model (that is, the first model and the third data), so that the sixth NF network element can obtain, from the storage address based on the first pointer, the first model, the data used to obtain the first model, or the data used to obtain the second model.

Optionally, the second information may further include second indication information, and the second indication information indicates whether the third NF network element stores the first data.

For example, because the second NF network element records the storage status of the data that is needed for the service requirement and that is in the third NF network element, the second NF network element may determine, by determining whether the first data is recorded, whether the third NF network element stores the first data. For example, if the second NF network element stores a hash value of the first data (in other words, the second NF network element records the first data), it indicates that the third NF network element stores the first data. If a hash value of the first data (in other words, the second NF network element does not record the first data) is not stored in the second NF network element, it indicates that the first data is not stored in the third NF network element.

Optionally, different functions of the second indication information may be indicated by using different bit values.

For example, the second indication information is indicated by using one bit. When the one bit is a first value, the second indication information indicates that the first data is not stored in the third NF network element. When the one bit is a second value, the first indication information indicates that the third NF network element stores the first data. Optionally, the first value may be 0, and correspondingly, the second value may be 1. Alternatively, the first value may be 1, and correspondingly, the second value may be 0.

It should be noted that the foregoing descriptions are merely an example in which a function of the second information may be indicated by using the first indication information and the second indication information. Actually, the function of the second information may alternatively be indicated by using one piece of indication information, in other words, the first indication information and the second indication information is combined into one piece of indication information. Details are not described in this application.

Optionally, the second information may further include a second pointer. For example, the second pointer may be implemented in the following two optional manners.

In an optional implementation, when the second indication information indicates that the third NF network element stores the first data, the second pointer indicates a fourth storage address. The fourth storage address is a storage address of the first data in the third NF network element.

In the other optional implementation, when the second indication information indicates that the first data is not stored in the third NF network element, the second pointer indicates a fifth storage address. The fifth storage address is a storage address of the first data in a fifth NF network element.

According to this optional solution, for different scenarios indicated by the second indication information (for example, whether the third NF network element stores the first data), the second pointer indicates storage addresses of the first data in the different scenarios, so that the sixth NF network element can obtain the first data based on the storage addresses.

Optionally, the second information may further include access strategy information. The access strategy information indicates whether the first NF network element has data access permission.

For example, the access strategy information may be indicated by using one bit. When the one bit is a first value, the access strategy information indicates that the first NF network element has the data access permission. When the one bit is a second value, the access strategy information indicates that the first NF network element does not have the data access permission. Optionally, the first value may be 0, and correspondingly, the second value may be 1. Alternatively, the first value may be 1, and correspondingly, the second value may be 0.

Optionally, that the second NF network element sends the second information to the sixth NF network element includes: The second NF network element sends a second message to the sixth NF network element, where the second message includes the second information and a digital signature of the second NF network element. In other words, the second information may be carried in the second message. The digital signature of the second NF network element is used to verify integrity of the second information.

Based on this optional solution, the digital signature of the second NF network element is used to ensure data security of the second information, to avoid reduction in accuracy of the response to the service requirement caused because the second message is tampered with.

Optionally, the second message may further include an ID of the second message. That is, as shown in FIG. 5, the second message may include the first indication information, the second indication information, the first pointer, the second pointer, the access strategy information, the digital signature of the second NF network element, and the ID of the second message.

According to the optional solution, the ID of the second message is used to ensure uniqueness of the second message, to avoid waste of resources caused because the system repeatedly determines the second message and further repeatedly performs response to the service requirement.

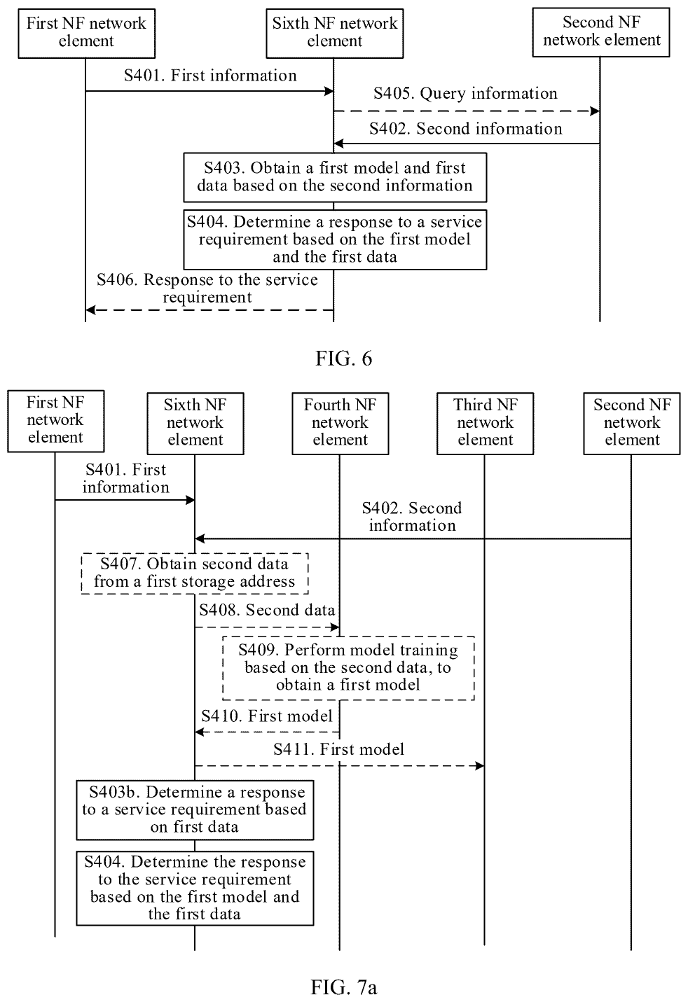

Optionally, before step S402, as shown in FIG. 6, the network function implementation method may further include step S405.

S405. The sixth NF network element sends query information to the second NF network element. Correspondingly, the second NF network element receives the query information from the sixth NF network element. The query information is used to query for the first model and the first data. The second NF network element sends the second information to the sixth NF network element based on triggering of the query information.

Optionally, after receiving the first information, the sixth NF network element sends the query information to the second NF network element. In other words, the sixth NF network element sends the query information to the second NF network element based on triggering of the first information.

S403. The sixth NF network element obtains the first model and the first data based on the second information.

Optionally, step S403 may include step S403a and step S403b.

Step S403a. Obtain the first model based on the second information.

Step S403b. Obtain first data based on the second information.

It should be noted that an execution sequence between step S403a and step S403b is not limited. For example, step S403a may be performed before step S403b; or step S403a may be performed after step S403b; or step S403a and step S403b may be performed simultaneously. This is not limited in embodiments of this application.

For step S403a,
optionally, when the first indication information indicates that the first model is not stored in the third NF network element, or the first indication information indicates that the third NF network element stores the first model and the first model does not need to be updated, the sixth NF network element obtains the first model based on the second information. Optionally, that the sixth NF network element obtains the first model based on the second information includes: The sixth NF network element obtains the first model based on the first indication information and the first pointer.

Optionally, when the first indication information indicates that the third NF network element stores the first model and the first model needs to be updated, after obtaining the first model based on the second information, the sixth NF network element may further obtain the second model based on the first model. The second model is an updated first model.

Optionally, that the sixth NF network element obtains the first model based on the second information includes: When the access strategy information indicates that the first NF network element has the data access permission, the sixth NF network element obtains the first model or the second model based on the second information. In other words, the sixth NF network element serves the first NF network element (for example, the sixth NF network element determines the response to the service requirement of the first NF network element). Therefore, the sixth NF network element needs to learn whether the first NF network element has the data access permission. Only when the first NF network element has the data access permission, the sixth NF network element can obtain, based on a case indicated by the first indication information, the first model or the second model from the storage address in the third NF network element indicated by the first pointer.

For step S403b,
optionally, that the sixth NF network element obtains the first data based on the second information includes: obtaining the first data based on the second indication information and the second pointer.

Optionally, that the sixth NF network element obtains the first data based on the second information includes: When the access strategy information indicates that the first NF network element has the data access permission, the sixth NF network element obtains the first data based on the second information. In other words, when the first NF network element has the data access permission, the sixth NF network element can obtain, based on a case indicated by the second indication information, the first data from the storage address that is in the third NF network element or the fifth NF network element and that is indicated by the second pointer.

In other words, before step S403, the sixth NF network element determines an indication of the access strategy information. When the access strategy information indicates that the first NF network element has the data access permission, the sixth NF network element performs step S403.

S404. The sixth NF network element determines the response to the service requirement based on the first model and the first data.

Optionally, when the first indication information indicates that the first model is not stored in the third NF network element, or the first indication information indicates that the third NF network element stores the first model and the first model does not need to be updated, the sixth NF network element determines the response to the service requirement based on the first model and the first data.

Optionally, when the first indication information indicates that the third NF network element stores the first model and the first model needs to be updated, that the sixth NF network element determines the response to the service requirement based on the first model and the first data includes: The sixth NF network element obtains the updated first model (that is, the second model) based on the first model, and determines the response to the service requirement based on the second model and the first data.

Optionally, the sixth NF network element inputs the first data into the first model or the second model, so that the first model or the second model outputs the response to the service requirement.

For example, when the service requirement is a data analysis requirement, the response to the service requirement is an analysis result corresponding to the data analysis requirement. For example, the data analysis requirement may be predicting a status of an event in a time period, and correspondingly, the response to the service requirement is status information of the event in the time period; or the data analysis requirement may be analyzing whether an alarm event is true or false, and correspondingly, the response to the service requirement is a result of analyzing whether the alarm event is true or false.

Optionally, when the first indication information indicates that the third NF network element stores the first model and the first model does not need to be updated, before step S404, the sixth NF network element may determine whether the first model is tampered with. When the first model is not tampered with, the sixth NF network element performs step S404. For example, determining whether the first model is tampered with may be implemented in the following three manners.

In a first optional implementation, the sixth NF network element may compare a first hash value of the first model with a second hash value of the first model, and when the first hash value is consistent with the second hash value, determine that the first model stored in the third NF network element is not tampered with. The first hash value is a hash value corresponding to the first model calculated by the third NF network element, and the second hash value is a hash value of the first model recorded in the second NF network element.

For example, the third NF network element may perform hash value calculation on the first model currently stored (that is, the currently latest first model) in the third NF network element, to determine the first hash value.

For example, when storing the first model for the first time, the third NF network element may calculate a hash value (referred to as the second hash value) of the first model that is stored for the first time, and send the second hash value to the second NF network element. The second NF network element receives and records the second hash value of the first model.

According to this optional implementation, the first model is stored off a chain (that is, in the third NF network element), and the second hash value of the first model is recorded on the chain (that is, in the second NF network element). Therefore, the first model stored off the chain may be tampered with. Before determining the response to the service requirement, the sixth NF network element may compare the fifth hash value with the second hash value, to determine whether the first model is tampered with. When the first hash value is consistent with the second hash value, it indicates that the first model is not tampered with. That is, after determining that the first model is not tampered with, the sixth NF network element determines the response to the service requirement based on the first model and the first data. This avoids determining the response to the service requirement by using a tampered first model. In this way, accuracy of the response to the service requirement is improved.

In a second optional implementation, the sixth NF network element may compare a fifth hash value of the first model with a second hash value of the first model, and when the fifth hash value is consistent with the second hash value, determine that the first model is not tampered with in a process of transmitting the first model from the third NF network element to the sixth NF network element. The fifth hash value is a hash value that corresponds to the first model and that is determined by the sixth NF network element, and the second hash value is a hash value that is of the first model and that is recorded in the second NF network element.

For example, the sixth NF network element may perform hash value calculation on the first model received from the third NF network element, to determine the fifth hash value.

According to this optional implementation, the first model may be tampered with in a process in which the third NF network element sends the first model to the sixth NF network element. Therefore, before determining the response to the service requirement, the sixth NF network element may compare the first hash value with the second hash value, to determine whether the first model is tampered with in the process of transmitting the first model from the third NF network element to the sixth NF network element. When the fifth hash value is consistent with the second hash value, it indicates that the first model is not tampered with. That is, after determining that the first model is not tampered with, the sixth NF network element determines the response to the service requirement based on the first model and the first data. This avoids determining the response to the service requirement by using a tampered first model. In this way, accuracy of the response to the service requirement is improved.

In a third optional implementation, the foregoing two optional implementations are combined. The sixth NF network element may compare a first hash value, a second hash value, and a fifth hash value, and when the first hash value, the second hash value, and the fifth hash value are consistent, determine that the first model is not tampered with.

Optionally, for manners of obtaining the first hash value, the second hash value, and the fifth hash value, refer to the manners of obtaining the first hash value, the second hash value, and the fifth hash value in the foregoing two optional implementations. Details are not described herein again in this application.

According to this optional implementation, because the first mode is stored off the chain (in the third NF network element), there is a risk that the first model is tampered with, and in a process of transmitting the first model from the third NF network element to the sixth NF network element, there is a risk that the first model is tampered with. Therefore, before determining the response to the service requirement, the sixth NF network element may compare the first hash value, the second hash value, and the fifth hash value, to determine whether the first model is tampered with. When the first hash value, the second hash value, and the first hash value are consistent, it indicates that the first model is not tampered with. That is, after determining that the first model is not tampered with, the sixth NF network element determines the response to the service requirement based on the first model and the first data. This avoids determining the response to the service requirement by using tampered first model. In this way, accuracy of the response to the service requirement is improved.

Optionally, when the first indication information indicates that the third NF network element stores the first model and the first model needs to be updated, or the first indication information indicates that the first model is not stored in the third NF network element, the sixth NF network element does not need to compare hash values.

Optionally, when the second indication information indicates that the third NF network element stores the first data, before step S404, the sixth NF network element may determine whether the first data is tampered with, and when the first data is not tampered with, the sixth NF network element performs step S404. For example, determining whether the first data is tampered with may be implemented in the following three manners.

In a first optional implementation, the sixth NF network element may compare a third hash value of the first data with a fourth hash value of the first data, and when the third hash value is consistent with the fourth hash value, determine that the first data stored in the third NF network element is not tampered with. The third hash value is a hash value that corresponds to the first data and that is calculated by the third NF network element, and the fourth hash value is a hash value that is of the first data and that is recorded in the second NF network element.

For example, the third NF network element may perform hash value calculation on the first data currently stored in the third NF network element, to determine the third hash value.

For example, when storing the first data for the first time, the third NF network element may calculate a hash value (referred to as the fourth hash value) of the first data that is stored for the first time, and send the fourth hash value to the second NF network element. The second NF network element receives and records the fourth hash value of the first data.

According to this optional implementation, the first data is stored off the chain (that is, in the third NF network element), and the fourth hash value of the first data is recorded on the chain (that is, in the second NF network element). Consequently, the first data stored off the chain may be tampered with. Before determining the response to the service requirement, the sixth NF network element compares the third hash value with the fourth hash value, to determine whether the first data is tampered with. When the third hash value is consistent with the fourth hash value, it indicates that the first data is not tampered with. That is, after determining that the first data is not tampered with, the sixth NF network element determines the response to the service requirement based on the first model and the first data. This avoids determining the response to the service requirement by using tampered first data. In this way, accuracy of the response to the service requirement is improved.

In a second optional implementation, the sixth NF network element may compare a sixth hash value of the first data with a fourth hash value of the first data, and when the sixth hash value is consistent with the fourth hash value, determine that the first data is not tampered with in a process of transmitting the first data from the third NF network element to the sixth NF network element. The sixth hash value is a hash value that corresponds to the first data and that is determined by the sixth NF network element, and the fourth hash value is a hash value that is of the first data and that is recorded in the second NF network element.

For example, the sixth NF network element may perform hash value calculation on the first data received from the third NF network element, to determine the sixth hash value.

Based on this optional solution, the first data may be tampered with in the process in which the third NF network element sends the first data to the sixth NF network element. Therefore, before determining the response to the service requirement, the sixth NF network element may compare the sixth hash value with the fourth hash value, to determine whether the first data is tampered with in the process of transmitting the first data from the third NF network element to the sixth NF network element. When the sixth hash value is consistent with the fourth hash value, it indicates that the first data is not tampered with. That is, after determining that the first data is not tampered with, the sixth NF network element determines the response to the service requirement based on the first model and the first data. This avoids determining the response to the service requirement by using tampered first data. In this way, accuracy of the response to the service requirement is improved.

In a third optional implementation, the foregoing two optional implementations are combined, the sixth NF network element may compare a third hash value, a fourth hash value, and a sixth hash value, and when the third hash value, the fourth hash value, and the sixth hash value are consistent, determine that the first data is not tampered with.

Optionally, for manners of obtaining the third hash value, the fourth hash value, and the sixth hash value, refer to the manners of obtaining the third hash value, the fourth hash value, and the sixth hash value in the foregoing two optional implementations. Details are not described herein again in this application.

According to this optional implementation, because the first data is stored off the chain (in the third NF network element), there is a risk that the first data is tampered with, and in a process of transmitting the first data from the third NF network element to the sixth NF network element, there is a risk that the first data is tampered with. Therefore, before determining the response to the service requirement, the sixth NF network element may compare the third hash value, the fourth hash value, and the sixth hash value, to determine whether the first data is tampered with. When the third hash value, the fourth hash value, and the sixth hash value are consistent, it indicates that the first data is not tampered with. To be specific, after determining that the first data is not tampered with, the sixth NF network element determines the response to the service requirement based on the first model and the first data. This avoids determining the response to the service requirement by using tampered first data. In this way, accuracy of the response to the service requirement is improved.

Optionally, after querying for the hash value of the first model or the hash value of the first data in at least one of the foregoing six optional implementations, the sixth NF network element may store a query record corresponding to this query.

For example, the query record may be stored on the chain (that is, in the second NF network element).

Optionally, the query record may include a quantity of times of querying for the hash value of the first model or the first data, and may further include a result of comparing hash values in this query (for example, the hash values are consistent or the hash values are inconsistent).

Optionally, after step S404, as shown in FIG. 6, the network function implementation method may further include step S406.

S406. The sixth NF network element sends the response corresponding to the service requirement to the first NF network element. Correspondingly, the first NF network element receives the response from the sixth NF network element.

According to the network function implementation method, the second NF network element is configured to record, by using a distributed ledger technology, the storage status of the data needed for implementing the service (that is, on-chain storage), and the third NF network element is configured to store the data by using a distributed hash table technology (that is, off-chain storage). Security of user data and security of user privacy are improved through a combination of the on-chain storage and the off-chain storage, thereby meeting a trustworthiness requirement on a distributed network architecture. When the trustworthiness requirement on the distributed network architecture is met, the sixth NF network element determines, from the second NF network element based on the model type and the data type that correspond to the service requirement, the storage status of the data needed for implementing the service requirement, further obtains, based on the storage status of the data, the first model and the first data that correspond to the service requirement, and determines the response to the service requirement based on the first data and the first model. Therefore, a network function can be implemented when the distributed network architecture meets the trustworthiness requirement.

The following describes obtaining of the first model in step S403a. For example, the first model in step S403a may be obtained based on the following two optional implementations.

In a first optional implementation, the sixth NF network element obtains, from the first storage address, the second data for training the first model, and further obtains the first model based on the second data.

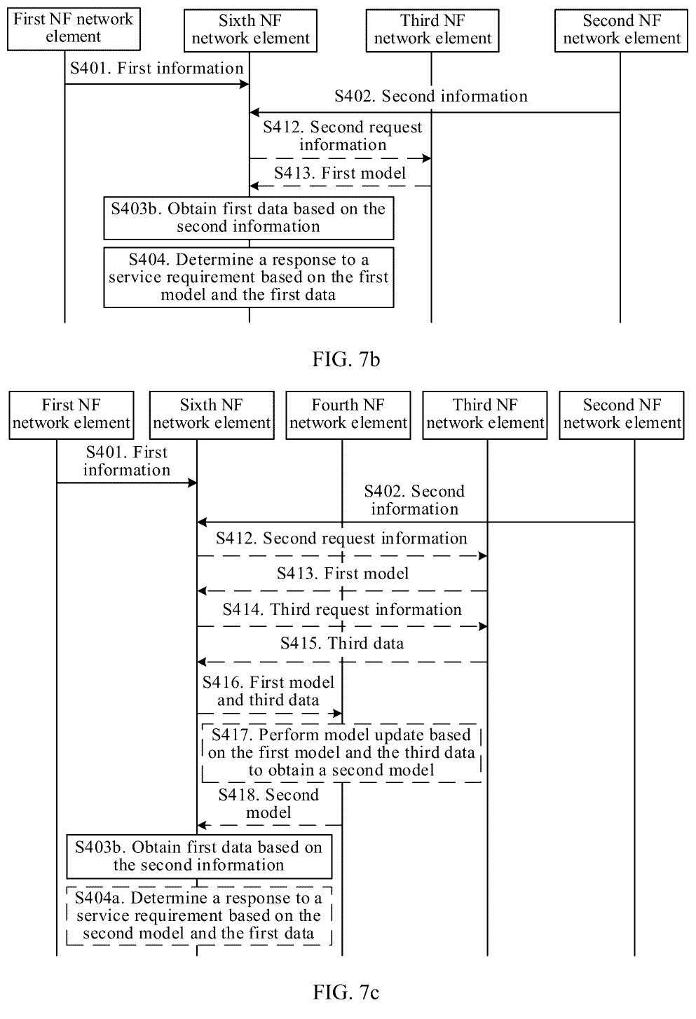

Optionally, when the first indication information indicates that the first model is not stored in the third NF network element, after step S402, as shown in FIG. 7a, the network function implementation method may include steps S407 to S410, in other words, step S403a may include steps S407 to S410.

S407. The sixth NF network element obtains the second data from the first storage address.

For example, the sixth NF network element may send first request information to the third NF network element, where the first request information is used to request the second data in the first storage address. After receiving the first request information, the third NF network element sends the second data to the sixth NF network element, so that the sixth NF network element obtains the second data.

S408. The sixth NF network element sends the second data to a fourth NF network element. Correspondingly, the fourth network element receives the second data from the sixth network element.

S409. The fourth NF network element performs model training based on the second data, to obtain the first model.

S410. The fourth NF network element sends the first model to the sixth NF network element. Correspondingly, the sixth NF network element receives the first model from the fourth NF network element.

Optionally, after step S410, as shown in FIG. 7a, the network function implementation method may further include step S411.

S411. The sixth NF network element sends the first model to the third NF network element. Correspondingly, the third NF network element receives the first model from the sixth NF network element. The third NF network element stores the first model.

According to the foregoing optional implementation, when the first model is not stored in the third NF network element, the sixth NF network element obtains, from the third NF network element, the second data used to train the first model, and then obtains the first model through training the first model by the fourth NF network element. In addition, the first model is stored in the third NF network element, so that when another NF network element needs to use the first model, the another NF network element can directly use the first model without retraining, thereby reducing resource consumption and improving system running efficiency.

In a second optional implementation, the sixth NF network element obtains the first model from the second storage address.

Optionally, when the first indication information indicates that the third NF network element stores the first model and the first model does not need to be updated, after step S402, as shown in FIG. 7b, the network function implementation method may include steps S412 and S413, in other words, step S403a may include steps S412 and S413.

S412. The sixth NF network element sends second request information to the third NF network element. Correspondingly, the third NF network element receives the second request information from the sixth NF network element. The second request information is used to request the first model in the second storage address.

For example, the second request information may carry the second storage address.

S413. The third NF network element sends the first model to the sixth NF network element. Correspondingly, the sixth NF network element receives the first model from the third network element.

According to the foregoing optional implementation, when the third NF network element stores the first model and the first model does not need to be updated, the sixth NF network element directly obtains the first model from the third NF network element. In this way, when another NF network element needs to use the first model, the another NF network element can directly use the first model without retraining, thereby reducing resource consumption and improving system running efficiency.

The foregoing describes the obtaining of the first model. The following describes obtaining of the second model in step S403a.

Optionally, the sixth NF network element obtains the first model from the second storage address, obtains the third data from the third storage address, and further obtains the second model based on the third data and the first model. The third data is used to update the first model.

Optionally, the sixth NF network element obtains the first model from the second storage address, obtains the third data from the third storage address, and updates the first model by using a fourth NF network element, to obtain the second model.

For example, for implementation in which the sixth NF network element obtains the first model from the second storage address, refer to the obtaining of the first model in steps S412 and S413. After step S413, as shown in FIG. 7c, the network function implementation method may include steps S414 to S418.

S414. The sixth NF network element sends third request information to the third NF network element. Correspondingly, the third NF network element receives the third request information from the sixth NF network element. The third request information is used to request the third data in the third storage address.

For example, the third request information may carry the third storage address.

S415. The third NF network element sends the third data to the sixth NF network element. Correspondingly, the sixth NF network element receives the third data from the third network element.

S416. The sixth NF network element sends the first model and the third data to the fourth NF network element. Correspondingly, the fourth NF network element receives the first model and the third data from the sixth NF network element.

S417. The fourth NF network element performs model update based on the first model and the third data to obtain the second model.

S418. The fourth NF network element sends the second model to the sixth NF network element. Correspondingly, the sixth NF network element receives the second model from the fourth NF network element.

Optionally, after step S418, the sixth NF network element may send the second model to the third NF network element, and the third NF network element stores the second model.

Optionally, the third NF network element stores the second model, calculates a hash value of the second model, and stores the hash value of the second model on the chain (in the second NF network element).

Optionally, when the sixth NF network element obtains the second model, after step S403, as shown in FIG. 7c, the sixth NF network element may perform step S404a.

S404a. The sixth NF network element determines the response to the service requirement based on the second model and the first data.

It should be noted that, steps S412 to S418 are merely an example of descriptions of a procedure of obtaining the second model. For an execution sequence between step S412 and step S414, and an execution sequence between step S413 and step S415, refer to an execution sequence between step S403a and step S403b. Details are not described in this application again.

The foregoing describes the obtaining of the second model. The following describes a manner of obtaining the first data in step S403b. For example, the first data may be obtained based on the following two optional implementations.

In a first optional implementation, the sixth NF network element obtains the first data from the third NF network element.

Optionally, that the sixth NF network element obtains the first data based on the second indication information and the second pointer includes: When the second indication information indicates that the third NF network element stores the first data, the sixth NF network element obtains the first data from the fourth storage address indicated by the second pointer.

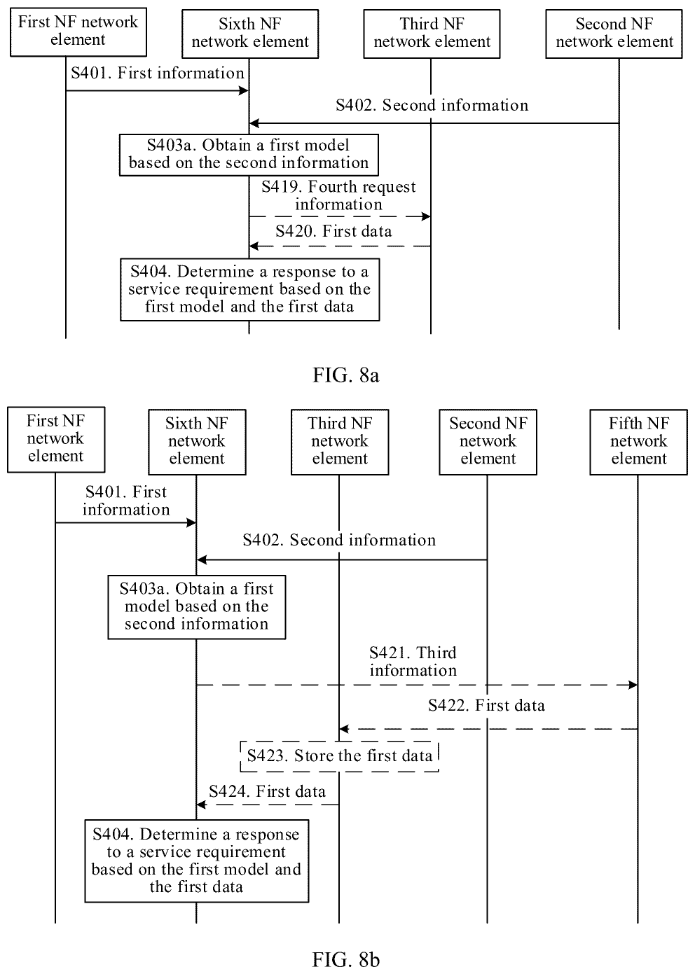

For example, when the second indication information indicates that the third NF network element stores the first data, after step S403a, as shown in FIG. 8a, the network function implementation method may include steps S419 and S420, in other words, step S403b may include steps S419 and S420.

S419. The sixth NF network element sends fourth request information to the third NF network element. Correspondingly, the third NF network element receives the fourth request information from the sixth NF network element. The fourth request information is used to request the first data in the fourth storage address.

For example, the fourth request information may carry the fourth storage address.

S420. The third NF network element sends the first data to the sixth NF network element. Correspondingly, the sixth NF network element receives the first data from the third network element.

In a second optional implementation, the sixth NF network element obtains the first data from the fifth NF network element.

Optionally, obtaining the first data based on the second indication information and the second pointer includes: When the second indication information indicates that the first data is not stored in the third NF network element, the sixth NF network element obtains the first data from the fifth storage address indicated by the second pointer.

When the second indication information indicates that the first data is not stored in the third NF network element, after step S403a, as shown in FIG. 8b, the network function implementation method may include steps S421 to S424, in other words, step S403b may include steps S421 to S424.

S421. The sixth NF network element sends third information to the fifth NF network element. Correspondingly, the fifth NF network element receives the third information from the sixth NF network element. The third information is used to request the fifth NF network element to store, in the third NF network element, the first data stored in the fifth storage address. S422.

The fifth NF network element sends the first data to the third NF network element. Correspondingly, the third NF network element receives the first data from the fifth NF network element.
S423. The third NF network element stores the first data.
S424. The third NF network element sends the first data to the sixth NF network element. Correspondingly, the sixth NF network element receives the first data from the third network element.

The foregoing describes the obtaining of the first data, and the following describes application scenarios of this embodiment of this application.

For example, based on indications of the first indication information and the second indication information, embodiments of this application may include the following six scenarios.
Scenario 1. The third NF network element stores the first model and the first data, and the first model does not need to be updated.

FIG. 9 is a distributed network architecture applicable to the scenario 1. The distributed network architecture includes the first NF network element, the second NF network element, the third NF network element, and the sixth NF network element for implementation. Interaction between the network elements in the distributed architecture may be shown in FIG. 9.

Specifically, the first NF network element may send the first information to the sixth NF network element. After receiving the first information, the sixth NF network element determines the first data corresponding to the data type and the model data corresponding to the model type, queries the second NF network element for the first data and the model data, and receives a query result (that is, the second information) from the second NF network element. In this case, the second information indicates that the third NF network element stores the first model and the first data, and the first model does not need to be updated. In other words, the model data includes the first model, and the second information includes the second storage address and the fourth storage address. Therefore, the sixth NF network element obtains the first model from the second storage address in the third NF network element, and obtains the first data from the fourth storage address in the third NF network element. The sixth NF network element determines, based on the first model and the first data, the response corresponding to the service requirement, and sends the response corresponding to the service requirement to the first NF network element.

Optionally, for a process in which the sixth NF network element obtains the first model from the third NF network element, refer to steps S412 and S413 in FIG. 7b. For a process in which the sixth NF network element obtains the first data from the third NF network element, refer to steps S419 and S420 in FIG. 8a. Details are not described in this application again.

It should be noted that steps S412 and S413 and steps S419 and S420 are merely example descriptions of a procedure of obtaining of the first model and a procedure of obtaining the first data. For an execution sequence between step S412 and step S419, and an execution sequence between step S413 and step S420, refer to an execution sequence between step S403a and step S403b. Details are not described in this application again.

Optionally, when step S412 and step S419 may be performed simultaneously, step S412 and step S419 may be combined into one step for execution. For example, the sixth NF network element sends sixth request information to the third NF network element, where the sixth request information is used to request the first model in the second storage address and the first data in the fourth storage address. In this case, it is equivalent to combining the second request information in step S412 and the fourth request information in step S419 into the sixth request information.
Scenario 2. The third NF network element stores the first data and the first model is not stored in the third NF network element.

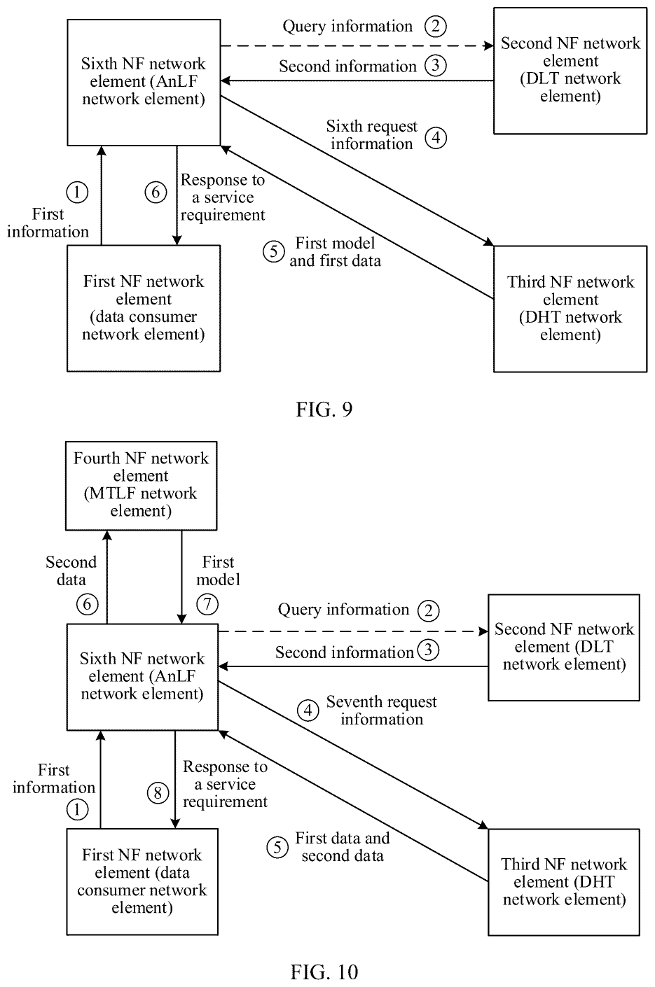

FIG. 10 is a distributed network architecture applicable to the scenario 2. The distributed network architecture includes the first NF network element, the second NF network element, the third NF network element, the fourth NF network element, and the sixth NF network element for implementation. Interaction between the network elements in the distributed architecture may be shown in FIG. 10.

Specifically, the first NF network element may send the first information to the sixth NF network element. After receiving the first information, the sixth NF network element determines the first data corresponding to the data type and the model data corresponding to the model type, queries the second NF network element for the first data and the model data, and receives a query result (that is, the second information) from the second NF network element. In this case, the second information indicates that the third NF network element stores the first data and the first model is not stored in the third NF network element. In other words, the model data includes the second data, and the second information includes the first storage address and the fourth storage address. Therefore, the sixth NF network element obtains the second data from the first storage address in the third NF network element, and obtains the first data from the fourth storage address in the third NF network element. After obtaining the second data, the sixth NF network element sends the second data to the fourth NF network element, and the fourth NF network element trains the first model based on the second data, and sends a trained first model to the sixth NF network element. The sixth NF network element determines, based on the trained first model and the first data, the response corresponding to the service requirement, and sends the response corresponding to the service requirement to the first NF network element.

Optionally, for a process in which the sixth NF network element obtains the second data from the third NF network element, and further obtains the first model based on the second data, refer to steps S407 to S410 in FIG. 7a. For a process in which the sixth NF network element obtains the first data from the third NF network element, refer to steps S419 and S420 in FIG. 8a. Details are not described in this application again.

Optionally, when the sixth NF network element obtains the second data by sending the first request information to the third NF network element in step S407, the first request information in step S407 and the fourth request information in step S419 may be combined into seventh request information. The seventh request information is used to request the second data in the first storage address and the first data in the fourth storage address.
Scenario 3: The third NF network element stores the first model and the first data is not stored in the third NF network element, and the first model does not need to be updated.

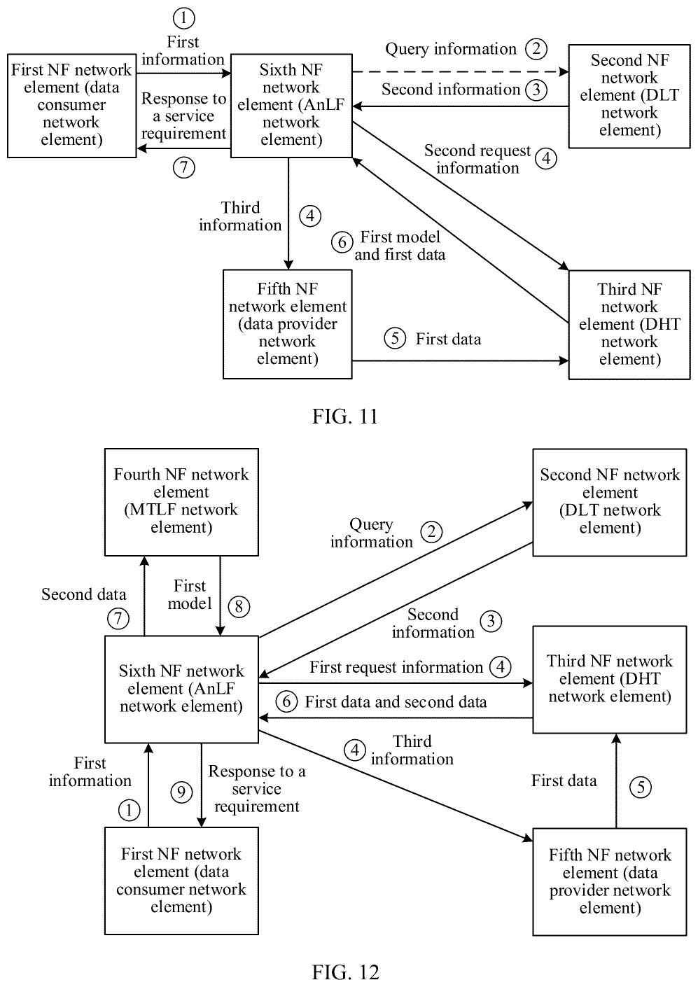

FIG. 11 is a distributed network architecture applicable to the scenario 3. The distributed network architecture includes the first NF network element, the second NF network element, the third NF network element, the fifth NF network element, and the sixth NF network element for implementation. Interaction between the network elements in the distributed architecture may be shown in FIG. 11.

Specifically, the first NF network element may send the first information to the sixth NF network element. After receiving the first information, the sixth NF network element determines the first data corresponding to the data type and the model data corresponding to the model type, queries the second NF network element for the first data and the model data, and receives a query result (that is, the second information) from the second NF network element. In this case, the second information indicates that the third NF network element stores the first model and the first data is not stored in the third NF network element, and the first model does not need to be updated. In other words, the model data includes the first model, and the second information includes the second storage address and the fifth storage address. Therefore, the sixth NF network element obtains the first model from the second storage address in the third NF network element, and obtains the first data from the fifth storage address in the fifth NF network element. In a process of obtaining the first data, the fifth NF network element first sends the first data to the third NF network element for storage, and then the third NF network element forwards the first data to the sixth NF network element. The sixth NF network element determines, based on the first model and the first data, the response corresponding to the service requirement, and sends the response corresponding to the service requirement to the first NF network element.

Optionally, for a process in which the sixth NF network element obtains the first model from the third NF network element, refer to steps S412 and S413 in FIG. 7b. For a process in which the sixth NF network element obtains the first data from the fifth NF network element, refer to steps S421 to S424 in FIG. 8b. Details are not described in this application again.

It should be noted that steps S412 and S413 and steps S421 to S424 are merely example descriptions of a procedure of obtaining the first model and a procedure of obtaining the first data. For an execution sequence between step S412 and step S421, and an execution sequence between step S413 and step S424, refer to an execution sequence between step S403a and step S403b. Details are not described in this application again.
Scenario 4. The first model and the first data are not stored in the third NF network element.

FIG. 12 is a distributed network architecture applicable to the scenario 4. The distributed network architecture includes the first NF network element, the second NF network element, the third NF network element, the fourth NF network element, the fifth NF network element, and the sixth NF network element for implementation. Interaction between the network elements in the distributed architecture may be shown in FIG. 12.

Specifically, the first NF network element may send the first information to the sixth NF network element. After receiving the first information, the sixth NF network element determines the first data corresponding to the data type and the model data corresponding to the model type, queries the second NF network element for the first data and the model data, and receives the second information from the second NF network element. In this case, the second information indicates that the first model is not stored in the third NF network element and the first data. In other words, the model data includes the second data, and the second information includes the first storage address and the fifth storage address. Therefore, the sixth NF network element obtains the second data from the first storage address in the third NF network element, and sends the second data to the fourth NF network element for model training, to obtain the first model. The sixth NF network element obtains the first data from the fifth storage address in the fifth NF network element. The sixth NF network element determines, based on the first model and the first data, the response corresponding to the service requirement, and sends the response corresponding to the service requirement to the first NF network element.

Optionally, for a process in which the sixth NF network element obtains the first model from the third NF network element, refer to steps S407 to S410 in FIG. 7a. For a process in which the sixth NF network element obtains the first data from the fifth NF network element, refer to steps S421 to S424 in FIG. 8b. Details are not described in this application again.

It should be noted that steps S407 to S410 and steps S421 to S424 are merely example descriptions of a procedure of obtaining the first model and a procedure of obtaining the first data. For an execution sequence between step S407 and step S421, and an execution sequence between step S410 and step S424, refer to an execution sequence between step S403a and step S403b. Details are not described in this application again.
Scenario 5. The third NF network element stores the first model and the first data, and the first model needs to be updated.

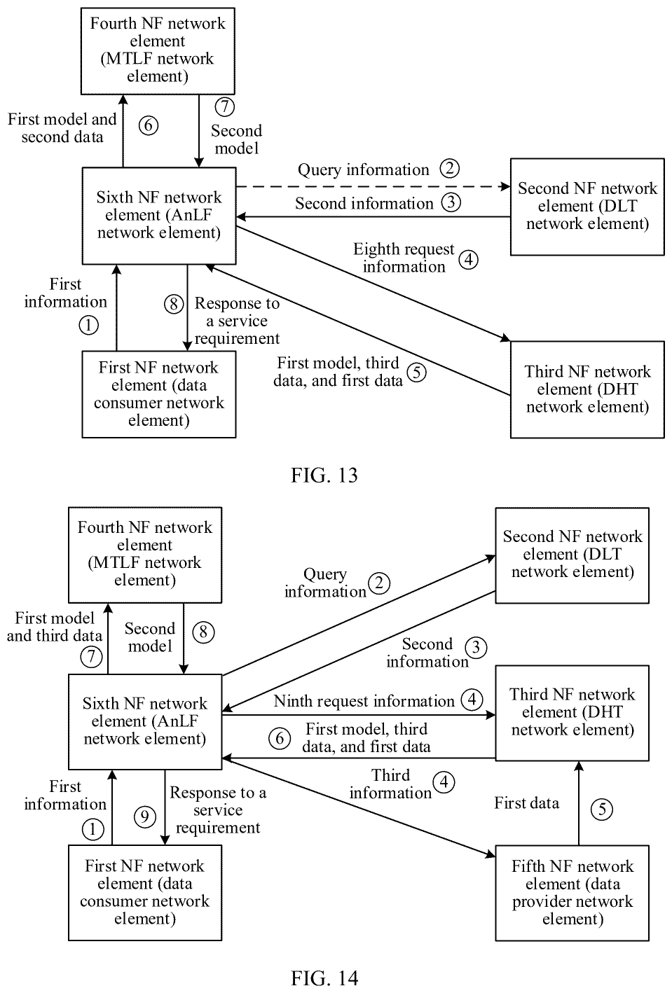

FIG. 13 is a distributed network architecture applicable to the scenario 5. The distributed network architecture includes the first NF network element, the second NF network element, the third NF network element, the fourth NF network element, and the sixth NF network element for implementation. Interaction between the network elements in the distributed architecture may be shown in FIG. 13.

Specifically, in the scenario 5, the first NF network element may send the first information to the sixth NF network element. After receiving the first information, the sixth NF network element determines the first data corresponding to the data type and the model data corresponding to the model type, queries the second NF network element for the first data and the model data, and receives the second information from the second NF network element. In this case, the second information indicates that the third NF network element stores the first model and the first data, and the first model needs to be updated. In other words, the model data includes the first model and the third data, and the second information includes the second storage address, the third storage address, and the fourth storage address. Therefore, the sixth NF network element obtains the first model from the second storage address in the third NF network element, obtains the third data from the third storage address in the third NF network element, and sends the first model and the third data to the fourth NF network element for model update, to obtain the second model. The sixth NF network element obtains the first data from the fourth storage address in the third NF network element. The sixth NF network element determines, based on the second model and the first data, the response corresponding to the service requirement, and sends the response corresponding to the service requirement to the first NF network element.

Optionally, for a process in which the sixth NF network element obtains the second model, refer to steps S412 to S418 in FIG. 7c. For a process in which the sixth NF network element obtains the first data, refer to steps S419 and S420 in FIG. 8a. Details are not described in this application again.

It should be noted that steps S412 to S418 and steps S419 and S420 are merely example descriptions of a procedure of obtaining the second model and a procedure of obtaining the first data. For an execution sequence between at least one of step S412 or step S414 and step S419, refer to an execution sequence between step S403a and step S403b. Details are not described in this application again.

Optionally, the second request information in step S412, the third request information in step S414, and the fourth request information in step S419 are combined into eighth request information shown in FIG. 13. The eighth request information is used to request the first model in the second storage address, the third data in the third storage address, and the first data in the fourth storage address.
Scenario 6. The third NF network element stores the first model and the first data is not stored in the third NF network element, and the first model needs to be updated.

FIG. 14 is a distributed network architecture applicable to the scenario 6. The distributed network architecture includes the first NF network element, the second NF network element, the third NF network element, the fourth NF network element, the fifth NF network element, and the sixth NF network element for implementation. Interaction between the network elements in the distributed architecture may be shown in FIG. 14.

Specifically, in the scenario 6, the first NF network element may send the first information to the sixth NF network element. After receiving the first information, the sixth NF network element determines the first data corresponding to the data type and the model data corresponding to the model type, queries the second NF network element for the first data and the model data, and receives the second information from the second NF network element. In this case, the second information indicates that the third NF network element stores the first model and the first data is not stored in the third NF network element, and the first model needs to be updated. In other words, the model data includes the first model and the third data, and the second information includes the second storage address, the third storage address, and the fifth storage address. Therefore, the sixth NF network element obtains the first model from the second storage address in the third NF network element, obtains the third data from the third storage address in the third NF network element, and sends the first model and the third data to the fourth NF network element for model update, to obtain the second model. The sixth NF network element obtains the first data from the fifth storage address in the fifth NF network element. The sixth NF network element determines, based on the second model and the first data, the response corresponding to the service requirement, and sends the response corresponding to the service requirement to the first NF network element.

Optionally, for a process in which the sixth NF network element obtains the second model, refer to steps S412 to S418 in FIG. 7c. For a process in which the sixth NF network element obtains the first data, refer to steps S421 to S424 in FIG. 8b. Details are not described in this application again.

It should be noted that steps S412 to S418 and steps S421 to S424 are merely example descriptions of a procedure of obtaining the second model and a procedure of obtaining the first data. For an execution sequence between at least one of step S412 or step S414 and step S421, and an execution sequence between at least one of step S413 or step S415 and step S424, refer to an execution sequence between step S403a and step S403b. Details are not described in this application again.

Optionally, the second request information in step S412 and the third request information in step S414 may be combined into ninth request information shown in FIG. 14. The ninth request information is used to request the first model in the second storage address, and the third data in the third storage address.

It may be understood that in the foregoing embodiments, the network function implementation method and/or the steps may alternatively be implemented by a component (for example, a processor, a chip, a chip system, a circuit, a logic module, or software such as a chip or a circuit) that may be used in a communication apparatus corresponding to the network function implementation method.

The above mainly describes the solutions provided in this application. Correspondingly, this application further provides a communication apparatus. The communication apparatus is configured to implement the foregoing methods. The communication apparatus may be the communication apparatus in the foregoing method embodiments, or may include the foregoing communication apparatus, or may be a component that may be used in the communication apparatus, for example, a chip or a chip system.

It may be understood that, to implement the foregoing functions, the communication apparatus includes a corresponding hardware structure and/or software module for performing the functions. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation exceeds the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

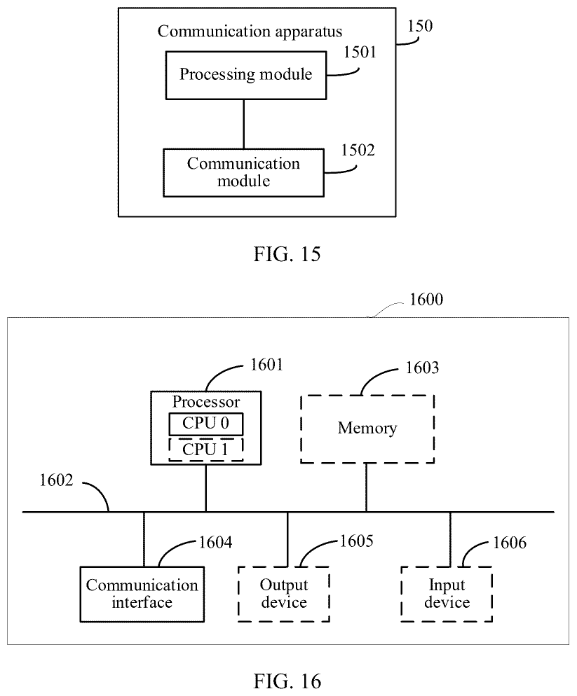

FIG. 15 is a diagram of a structure of a communication apparatus 150. The communication apparatus 150 includes a processing module 1501 and a communication module 1502. The communication apparatus 150 may be configured to implement functions of the foregoing NF network elements.

In some embodiments, the communication apparatus 150 may further include a storage module (not shown in FIG. 15), configured to store program instructions and data.

In some embodiments, the communication module 1502 may also be referred to as a transceiver unit, configured to implement a sending function and/or a receiving function. The communication module 1502 may include a transceiver circuit, a transceiver machine, a transceiver, or a communication interface.

In some embodiments, the communication module 1502 may include a receiving module and a sending module, respectively configured to perform receiving and sending steps performed by the NF network elements in the foregoing method embodiments, and/or configured to support another process of the technology described in this specification. The processing module 1501 may be configured to perform processing (for example, determining and generating) steps performed by the NF network elements in the foregoing method embodiments, and/or configured to support another process of the technology described in this specification.

When the communication apparatus 150 is configured to implement the functions of the sixth NF network element,
in some embodiments, the communication module 1502 is configured to receive first information from a first NF network element, where the first information indicates a model type and a data type that correspond to a service requirement of the first NF network element; the communication module 1502 is further configured to receive second information from a second NF network element, where the second information indicates a storage status of data needed for fulfilling the service requirement within a third NF network element; the processing module 1501 is configured to obtain a first model and first data based on the second information; and the processing module 1501 is further configured to determine a response to the service requirement based on the first model and the first data.

The second NF network element is configured to record the storage status of the data by using a distributed ledger technology, the third NF network element is configured to store the data by using a distributed hash table technology, the data includes model data corresponding to the model type and the first data corresponding to the data type, and the model data is used to determine the first model.

Optionally, the second NF network element may be a DLT network element, and the third NF network element may be a DHT network element.

Optionally, the second information includes first indication information, the first indication information indicates whether the third NF network element stores the first model, and when the first indication information indicates that the third NF network element stores the first model, the first indication information further indicates whether the first model needs to be updated. When the first indication information indicates that the first model is not stored in the third NF network element, the model data includes second data, where the second data is used to obtain the first model through training; when the first indication information indicates that the third NF network element stores the first model and the first model does not need to be updated, the model data includes the first model; or when the first indication information indicates that the third NF network element stores the first model and the first model needs to be updated, the model data includes the first model and third data, where the third data is used to update the first model to obtain a second model.

Optionally, the second information further includes a first pointer. When the first indication information indicates that the first model is not stored in the third NF network element, the first pointer indicates a first storage address, where the first storage address is a storage address of the second data in the third NF network element, and the second data is used to train the first model; when the first indication information indicates that the third NF network element stores the first model and the first model does not need to be updated, the first pointer indicates a second storage address, where the second storage address is a storage address of the first model in the third NF network element; or when the first indication information indicates that the third NF network element stores the first model and the first model needs to be updated, the first pointer indicates a third storage address and the second storage address, where the third storage address is a storage address of the third data in the third NF network element, and the third data is used to update the first model.

Optionally, the processing module 1501 is further configured to obtain the first model from the second storage address.

Optionally, the processing module 1501 is further configured to obtain the second data from the first storage address. The communication module 1502 is further configured to: send the second data to a fourth NF network element; and receive the first model from the fourth NF network element. The communication module 1502 is further configured to send the first model to the third NF network element.

Optionally, the processing module 1501 is further configured to obtain third data from the third storage address; the communication module 1502 is further configured to send the third data and the first model to the fourth NF network element; and the communication module 1502 is further configured to receive the second model from the fourth NF network element, where the second model is an updated first model.

Optionally, the processing module 1501 is further configured to determine the response to the service requirement based on the second model and the first data.

Optionally, the communication module 1502 is further configured to send the second model to the third NF network element.

Optionally, when the first indication information indicates that the third NF network element stores the first model and the first model needs to be updated, the first pointer includes a first sub-pointer and a second sub-pointer, where the first sub-pointer indicates the third storage address, and the second sub-pointer indicates the second storage address.

Optionally, the second information further includes second indication information, and the second indication information indicates whether the third NF network element stores the first data.

Optionally, the second information further includes a second pointer. When the second indication information indicates that the third NF network element stores the first data, the second pointer indicates a fourth storage address, where the fourth storage address is a storage address of the first data in the third NF network element; or when the second indication information indicates that the first data is not stored in the third NF network element, the second pointer indicates a fifth storage address, where the fifth storage address is a storage address of the first data in a fifth NF network element, and the fifth NF network element is configured to provide data corresponding to the service requirement.

Optionally, the processing module 1501 is further configured to obtain the first data based on the second indication information and the second pointer.

Optionally, the processing module 1501 is further configured to obtain the first data from the fourth storage address.

Optionally, the communication module 1502 is further configured to send third information to the fifth NF network element, where the third information is used to request the fifth NF network element to store, in the third NF network element, the first data stored in the fifth storage address; and the communication module 1502 is further configured to receive the first data from the third NF network element.

Optionally, the communication module 1502 is further configured to receive a first message from the first NF network element, where the first message includes the first information and a digital signature of the first NF network element.

Optionally, the second information further includes access strategy information, and the access strategy information indicates whether the first NF network element has data access permission.

Optionally, the processing module 1501 is further configured to: compare a first hash value of the first model with a second hash value of the first model, where the first hash value is a hash value that is of the first model and that is determined by the sixth NF network element, and the second hash value is a hash value that is of the first model and that is recorded in the second NF network element; and when the first hash value is consistent with the second hash value, determine the response to the service requirement based on the first model and the first data.

Optionally, the processing module 1501 is further configured to: compare a third hash value of the first data with a fourth hash value of the first data, where the third hash value is a hash value that is of the first data and that is determined by the sixth NF network element, and the fourth hash value is a hash value that is of the first data and that is recorded in the second NF network element; and when the third hash value is consistent with the fourth hash value, determine the response to the service requirement based on the first model and the first data.

Optionally, the processing module 1501 is further configured to: compare a first hash value of the first model with a second hash value of the first model, where the first hash value is a hash value of the first model calculated by the third NF network element, and the second hash value is a hash value of the first model recorded in the second NF network element; and when the first hash value is consistent with the second hash value, determine the response to the service requirement based on the first model and the first data.

Optionally, the processing module 1501 is further configured to: compare a fifth hash value of the first model with a second hash value of the first model, where the fifth hash value is a hash value that is of the first model and that is determined by the sixth NF network element, and the second hash value is a hash value that is of the first model and that is recorded in the second NF network element; and when the fifth hash value is consistent with the second hash value, determine the response to the service requirement based on the first model and the first data.

Optionally, the processing module 1501 is further configured to: compare a third hash value of the first data with a fourth hash value of the first data, where the third hash value is a hash value of the first data calculated by the third NF network element, and the fourth hash value is a hash value that is of the first data and that is recorded in the second NF network element; and when the third hash value is consistent with the fourth hash value, determine the response to the service requirement based on the first model and the first data.

Optionally, the processing module 1501 is further configured to: compare a sixth hash value of the first data with a fourth hash value of the first data, where the sixth hash value is a hash value that is of the first data and that is determined by the sixth NF network element, and the fourth hash value is a hash value that is of the first data and that is recorded in the second NF network element; and when the sixth hash value is consistent with the fourth hash value, determine the response to the service requirement based on the first model and the first data.

All related content of the steps in the foregoing method embodiments may be cited in function descriptions of the corresponding functional modules. Details are not described herein again.

In this application, the communication apparatus 150 is presented in a form of functional modules obtained through division in an integrated manner. The “module” herein may be an application-specific integrated circuit (ASIC), a circuit, a processor that executes one or more software or firmware programs, a memory, an integrated logic circuit, and/or another component that can provide the foregoing functions.

In some embodiments, when the communication apparatus 150 in FIG. 15 is a chip or a chip system, a function/implementation process of the communication module 1502 may be implemented by using an input/output interface (or a communication interface) of the chip or the chip system, and a function/implementation process of the processing module 1501 may be implemented by using a processor (or a processing circuit) of the chip or the chip system.

The communication apparatus 150 provided in this embodiment may perform the foregoing method. Therefore, for technical effects that can be achieved by the communication apparatus 150, refer to the foregoing method embodiments. Details are not described herein again.

As an optional product form, the communication apparatus in embodiments of this application may alternatively be implemented by using the following: one or more field programmable gate arrays (FPGA), a programmable logic device (PLD), a controller, a state machine, gate logic, and a discrete hardware component, any other proper circuit, or any combination of circuits that can perform various functions described throughout this application.

As another optional product form, the communication apparatus in this application may use a composition structure shown in FIG. 16, or include components shown in FIG. 16. FIG. 16 is a composition diagram of a communication apparatus 1600 according to this application. The communication apparatus 1600 may be a communication apparatus, or a chip or a system on chip in the communication apparatus.

As shown in FIG. 16, the communication apparatus 1600 includes at least one processor 1601 and at least one communication interface (in FIG. 16, only an example in which one communication interface 1604 and one processor 1601 are included is used for description). Optionally, the communication apparatus 1600 may further include a communication bus 1602 and a memory 1603.

The processor 1601 may be a general-purpose central processing unit (CPU), a general-purpose processor, a network processor (NP), a digital signal processor (DSP), a microprocessor, a microcontroller, a programmable logic device (PLD), or any combination thereof. The processor 1601 may alternatively be another apparatus having a processing function, for example, a circuit, a component, or a software module. This is not limited.

The communication bus 1602 is configured to connect different components in the communication apparatus 1600, so that the different components can communicate with each other. The communication bus 1602 may be a peripheral component interconnect (PCI) bus, an extended industry standard architecture (EISA) bus, or the like. The bus may be classified into an address bus, a data bus, a control bus, and the like. For ease of representation, only one bold line is used to represent the bus in FIG. 16, but this does not mean that there is only one bus or only one type of bus.

The communication interface 1604 is configured to communicate with another device or a communication network. For example, the communication interface 1604 may be a module, a circuit, a transceiver, or any apparatus that can implement communication. Optionally, the communication interface 1604 may alternatively be an input/output interface located in the processor 1601, and is configured to implement signal input and signal output of the processor.

The memory 1603 may be an apparatus having a storage function, and is configured to store instructions and/or data. The instructions may be a computer program.

For example, the memory 1603 may be a read-only memory (ROM) or another type of static storage device that can store static information and/or instructions, or may be a random access memory (RAM) or another type of dynamic storage device that can store information and/or instructions, or may be an electrically erasable programmable read-only memory (EEPROM), a compact disc read-only memory (CD-ROM) or another optical disc storage, an optical disc storage (including a compressed optical disc, a laser disc, an optical disc, a digital versatile disc, a Blu-ray disc, or the like), a disk storage medium, or another magnetic storage device. This is not limited.

It should be noted that the memory 1603 may exist independently of the processor 1601, or may be integrated with the processor 1601. The memory 1603 may be located inside the communication apparatus 1600, or may be located outside the communication apparatus 1600. This is not limited. The processor 1601 may be configured to execute the instructions stored in the memory 1603, to implement the method provided in the following embodiments of this application.

In an optional implementation, the communication apparatus 1600 may further include an output device 1605 and an input device 1606. The output device 1605 communicates with the processor 1601, and may display information in a plurality of manners. For example, the output device 1605 may be a liquid crystal display (LCD), a light emitting diode (LED) display device, a cathode ray tube (CRT) display device, or a projector. The input device 1606 communicates with the processor 1601, and may receive an input from a user in a plurality of manners. For example, the input device 1606 may be a mouse, a keyboard, a touchscreen device, or a sensor device.

In some embodiments, in hardware implementation, a person skilled in the art may figure out that the communication apparatus 150 may be in a form of the communication apparatus 1600 shown in FIG. 16.

In an example, functions/implementation processes of the processing module 1501 in FIG. 15 may be implemented by the processor 1601 in the communication apparatus 1600 shown in FIG. 16 by invoking computer-executable instructions stored in the memory 1603. Functions/implementation processes of the communication module 1502 in FIG. 15 may be implemented by the communication interface 1604 in the communication apparatus 1600 shown in FIG. 16.

It should be noted that the structure shown in FIG. 16 does not constitute a specific limitation on the communication apparatus. For example, in some other embodiments of this application, the communication apparatus may include more or fewer components than those shown in the figure, or some components may be combined, or some components may be split, or different component arrangements may be used. The components shown in the figure may be implemented by hardware, software, or a combination of software and hardware.

In some embodiments, an embodiment of this application further provides a communication apparatus. The communication apparatus includes a processor, configured to implement the method according to any one of the foregoing method embodiments.

As an optional implementation, the communication apparatus further includes a memory. The memory is configured to store a necessary computer program and data. The computer program may include instructions. The processor may invoke the instructions in the computer program stored in the memory, to instruct the communication apparatus to perform the method in any one of the foregoing method embodiments. Certainly, the communication apparatus may not include a memory.

In another optional implementation, the communication apparatus further includes an interface circuit. The interface circuit is a code/data read/write interface circuit, and the interface circuit is configured to receive computer-executable instructions (the computer-executable instructions are stored in the memory, and may be read from the memory directly or through another component) and transmit the computer-executable instructions to the processor.

In still another optional implementation, the communication apparatus further includes a communication interface, and the communication interface is configured to communicate with a module other than the communication apparatus.

It may be understood that the communication apparatus may be a chip or a chip system. When the communication apparatus is a chip system, the communication apparatus may include a chip, or may include a chip and another discrete component. This is not specifically limited in embodiments of this application.

This application further provides a computer-readable storage medium. The computer-readable storage medium stores a computer program or instructions. When the computer program or instructions are executed by a computer, functions in any one of the foregoing method embodiments are implemented.

This application further provides a computer program product. When the computer program product is executed by a computer, functions of any one of the foregoing method embodiments are implemented.

A person of ordinary skill in the art may understand that, for the purpose of convenient and brief description, for a detailed working process of the foregoing system, apparatuses, and units, refer to a corresponding process in the foregoing method embodiments. Details are not described herein again.

It may be understood that the system, apparatus, and method described in this application may alternatively be implemented in another manner. For example, the described apparatus embodiment is merely an example. For example, division into the units is merely logical function division and may be other division in actual implementations. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separated, and may be located in one place or may be distributed over a plurality of network units. Components shown as units may or may not be physical units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

All or some of the foregoing embodiments may be implemented by using software, hardware, firmware, or any combination thereof. When software is used to implement embodiments, all or some of embodiments may be implemented in the form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk drive, or a magnetic tape), an optical medium (for example, a DVD), a semiconductor medium (for example, a solid-state disk (SSD)), or the like. In embodiments of this application, the computer may include the foregoing apparatuses.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a good effect.

Although this application is described with reference to specific features and embodiments thereof, it is clear that various modifications and combinations may be made to them without departing from the scope of this application. Correspondingly, the specification and accompanying drawings are merely example descriptions of this application defined by the appended claims, and are considered as any of or all modifications, variations, combinations or equivalents that cover the scope of this application. It is clear that a person skilled in the art can make various modifications and variations to this application without departing from the scope of this application. In this case, if the modifications and variations made to this application fall within the scope of the claims of this application and their equivalent technologies, this application is intended to include these modifications and variations.

1. A network function implementation method, wherein the method comprises:
receiving first information from a first network function (NF) network element, wherein the first information indicates a model type and a data type that correspond to a service requirement of the first NF network element;
receiving second information from a second NF network element, wherein the second information indicates a storage status of data stored in a third NF network element and needed for fulfilling the service requirement, the second NF network element is configured to record the storage status of the data using a distributed ledger technology, the third NF network element is configured to store the data using a distributed hash table technology, the data comprises model data corresponding to the model type and first data corresponding to the data type, and the model data is used to determine a first model;
obtaining the first model and the first data based on the second information; and
determining a response to the service requirement based on the first model and the first data.

2. The method according to claim 1, wherein the second information comprises first indication information; and
the first indication information indicates whether the third NF network element stores the first model, and when the first indication information indicates that the third NF network element stores the first model, the first indication information further indicates whether the first model needs to be updated, wherein
the first indication information indicates that the first model is not stored in the third NF network element, and the model data comprises second data, wherein the second data is used to obtain the first model through training;
the first indication information indicates that the third NF network element stores the first model and the first model does not need to be updated, and the model data comprises the first model; or
the first indication information indicates that the third NF network element stores the first model and the first model needs to be updated, and the model data comprises the first model and third data, wherein the third data is used to update the first model to obtain a second model.

3. The method according to claim 2, wherein the second information further comprises a first pointer; and
the first indication information indicates that the first model is not stored in the third NF network element, and the first pointer indicates a first storage address, wherein the first storage address is a storage address of the second data in the third NF network element;
the first indication information indicates that the third NF network element stores the first model and the first model does not need to be updated, and the first pointer indicates a second storage address, wherein the second storage address is a storage address of the first model in the third NF network element; or
the first indication information indicates that the third NF network element stores the first model and the first model needs to be updated, and the first pointer indicates a third storage address and the second storage address, wherein the third storage address is a storage address of the third data in the third NF network element.

4. The method according to claim 3, wherein the first indication information indicates that the first model is not stored in the third NF network element, and obtaining the first model based on the second information comprises:
obtaining the second data from the first storage address;
sending the second data to a fourth NF network element, wherein the fourth NF network element is configured to obtain the first model through training; and
receiving the first model from the fourth NF network element.

5. The method according to claim 4, wherein the method further comprises:
sending the first model to the third NF network element.

6. The method according to claim 3, wherein the first indication information indicates that the third NF network element stores the first model and the first model does not need to be updated, and obtaining the first model based on the second information comprises:
obtaining the first model from the second storage address.

7. The method according to claim 6, wherein the determining the response to the service requirement based on the first model and the first data comprises:
comparing a first hash value of the first model with a second hash value of the first model, wherein the first hash value is a hash value of the first model calculated by the third NF network element, and the second hash value is a hash value of the first model recorded in the second NF network element; and
in response to the first hash value being consistent with the second hash value, determining the response to the service requirement based on the first model and the first data.

8. The method according to claim 3, wherein the third NF network element stores the first model and the first model needs to be updated, and obtaining the first model based on the second information comprises:
obtaining the first model from the second storage address; and
obtaining the third data from the third storage address; and
the method further comprises:
sending the third data and the first model to a fourth NF network element; and
receiving the second model from the fourth NF network element.

9. The method according to claim 8, wherein the method further comprises:
sending the second model to the third NF network element.

10. The method according to claim 8, wherein the first indication information indicates that the third NF network element stores the first model and the first model needs to be updated, and the first pointer comprises a first sub-pointer and a second sub-pointer, wherein the first sub-pointer indicates the third storage address, and the second sub-pointer indicates the second storage address.

11. The method according to claim 8, wherein the determining the response to the service requirement based on the first model and the first data comprises:
determining the response to the service requirement based on the second model and the first data.

12. The method according to claim 1, wherein the second information comprises second indication information, and the second indication information indicates whether the third NF network element stores the first data.

13. The method according to claim 12, wherein the second information further comprises a second pointer; and
the second indication information indicates that the third NF network element stores the first data, and the second pointer indicates a fourth storage address, wherein the fourth storage address is a storage address of the first data in the third NF network element; or
the second indication information indicates that the first data is not stored in the third NF network element, and the second pointer indicates a fifth storage address, wherein the fifth storage address is a storage address of the first data in a fifth NF network element.

14. The method according to claim 13, wherein the second indication information indicates that the third NF network element stores the first data, and obtaining the first data based on the second information comprises:
obtaining the first data from the fourth storage address.

15. The method according to claim 14, wherein the determining the response to the service requirement based on the first model and the first data comprises:
comparing a third hash value of the first data with a fourth hash value of the first data, wherein the third hash value is a hash value of the first data calculated by the third NF network element, and the fourth hash value is a hash value of the first data recorded in the second NF network element; and
in response to the third hash value being consistent with the fourth hash value, determining the response to the service requirement based on the first model and the first data.

16. The method according to claim 13, wherein the second indication information indicates that the first data is not stored in the third NF network element, and obtaining the first data based on the second information comprises:
sending third information to the fifth NF network element, wherein the third information is used to request the fifth NF network element to store, in the third NF network element, the first data stored in the fifth storage address; and
receiving the first data from the third NF network element.

17. The method according to claim 1, wherein receiving the first information from the first NF network element comprises:
receiving a first message from the first NF network element, wherein the first message comprises the first information and a digital signature of the first NF network element.

18. The method according to claim 1, wherein the second information further comprises access strategy information, and the access strategy information indicates whether the first NF network element has data access permission.

19. A network function implementation apparatus, wherein the network function implementation apparatus comprises a processor and a memory comprising instructions, and the processor is configured to run a computer program or execute the instructions, to cause the network function implementation apparatus to perform:
receiving first information from a first network function (NF) network element, wherein the first information indicates a model type and a data type that correspond to a service requirement of the first NF network element;
receiving second information from a second NF network element, wherein the second information indicates a storage status of data stored in a third NF network element and needed for fulfilling the service requirement, the data comprises model data corresponding to the model type and first data corresponding to the data type, and the model data is used to determine a first model;
obtaining the first model and the first data based on the second information; and
determining a response to the service requirement based on the first model and the first data.

20. A non-transitory computer-readable storage medium, wherein the non-transitory computer-readable storage medium stores computer instructions or a program, and when the computer instructions or the program is run on a computer, cause the computer to:
receive first information from a first network function (NF) network element, wherein the first information indicates a model type and a data type that correspond to a service requirement of the first NF network element;
receive second information from a second NF network element, wherein the second information indicates a storage status of data stored in a third NF network element and needed for fulfilling the service requirement, the data comprises model data corresponding to the model type and first data corresponding to the data type, and the model data is used to determine a first model;
obtain the first model and the first data based on the second information; and
determine a response to the service requirement based on the first model and the first data.
